(19) United States
(12) Patent Application Publication
(10) Pub. No.: US 2026/0189134 A1
(43) Pub. Date: Jul. 2, 2026

(54) TURN-ON PROCEDURE FOR A LOAD CONTROL DEVICE

(71) Applicant: Lutron Technology Company LLC, Coopersburg, PA (US)

(72) Inventors: Steven J. Kober, Center Valley, PA (US); Soma Sekhara Rao Konijeti, Bengaluru (IN); Rajesh Krishna Thottumkara, New Milford, NJ (US); Keertana Veeranki, Bethlehem, PA (US)

(73) Assignee: Lutron Technology Company LLC, Coopersburg, PA (US)

(21) Appl. No.: 19/549,204

(22) Filed: Feb. 25, 2026

Related U.S. Application Data
(63) Continuation of application No. 18/794,263, filed on Aug. 5, 2024, now Pat. No. 12,587,091.
Application No. 18/794,263 is a continuation of application No. 18/477,969, filed on Sep. 29, 2023, now Pat. No. 12,088,193.
Application No. 18/477,969 is a continuation of application No. 17/855,863, filed on Jul. 1, 2022, now Pat. No. 11,811,305.
Application No. 17/855,863 is a continuation of application No. 16/845,131, filed on Apr. 10, 2020, now Pat. No. 11,381,156.
Application No. 16/845,131 is a continuation of application No. 16/427,258, filed on May 30, 2019, now Pat. No. 10,645,776.
Application No. 16/427,258 is a continuation of application No. 15/904,130, filed on Feb. 23, 2018, now Pat. No. 10,314,129.
(60) Provisional application No. 62/463,159, filed on Feb. 24, 2017.
(60) Provisional application No. 62/562,008, filed on Sep. 22, 2017.
(60) Provisional application No. 62/580,671, filed on Nov. 2, 2017.

(51) Int. Cl. H02M 1/36; H02M 3/335; H05B 45/14; H05B 45/3725; H05B 45/375; H05B 45/38; H05B 45/385; H05B 47/165

(52) U.S. Cl. CPC H02M 1/36; H05B 45/14; H05B 45/3725; H05B 45/385; H05B 47/165; H02M 3/33507; H05B 45/375; H05B 45/38

(57) ABSTRACT

A load control device may be configured to turn on lighting loads to obtain a fast turn-on time that may be substantially consistent across lighting loads that have different load voltages. The load control device may comprise a power converter circuit configured to produce a voltage across a capacitor, and a control circuit configured to control the power converter circuit to generate the voltage across the capacitor. The control circuit may determine a learned voltage from the magnitude of the voltage across the capacitor. For example, the control circuit may measure the magnitude of the voltage and store the measured voltage as the learned voltage. The control circuit may determine an operating parameter for the power converter circuit as a function of the learned voltage, and control the power converter circuit according to the operating parameter to charge the capacitor until the magnitude of the voltage exceeds a threshold.

### CROSS-REFERENCE TO RELATED APPLICATIONS

This application is a continuation of U.S. patent application Ser. No. 18/794,263, filed Aug. 5, 2024; which is a continuation of U.S. patent application Ser. No. 18/477,969, filed Sep. 29, 2023, now U.S. Pat. No. 12,088,193, issued Sep. 10, 2024; which is a continuation of U.S. patent application Ser. No. 17/855,863, filed Jul. 1, 2022, now U.S. Pat. No. 11,811,305, issued Nov. 7, 2023; which is a continuation of U.S. patent application Ser. No. 16/845,131 filed Apr. 10, 2020, now U.S. Pat. No. 11,381,156 issued Jul. 5, 2022; which is a continuation of U.S. patent application Ser. No. 16/427,258, filed May 30, 2019, now U.S. Pat. No. 10,645,776 issued May 5, 2020; which is a continuation of U.S. patent application Ser. No. 15/904,130, filed Feb. 23, 2018, now U.S. Pat. No. 10,314,129, issued Jun. 4, 2019; which claims the benefit of U.S. Provisional Patent Application No. 62/463,159 , filed Feb. 24, 2017, U.S. Provisional Patent Application No. 62/562,008, filed Sep. 22, 2017, and U.S. Provisional Patent Application No. 62/580,671 , filed Nov. 2, 2017, the entire disclosures of which are hereby incorporated by reference.

### BACKGROUND OF THE INVENTION

Light-emitting diode (LED) light sources (e.g., LED light engines) are replacing conventional incandescent, fluorescent, and halogen lamps as a primary form of lighting devices. LED light sources may comprise a plurality of light-emitting diodes mounted on a single structure and provided in a suitable housing. LED light sources may be more efficient and provide longer operational lives as compared to incandescent, fluorescent, and halogen lamps. An LED driver control device (e.g., an LED driver) may be coupled between a power source, such as an alternating-current (AC) power source or a direct-current (DC) power source, and an LED light source for regulating the power supplied to the LED light source. For example, the LED driver may regulate the voltage provided to the LED light source, the current supplied to the LED light source, or both the current and voltage.

Different control techniques may be employed to drive LED light sources including, for example, a current load control technique and a voltage load control technique. An LED light source driven by the current load control technique may be characterized by a rated current (e.g., approximately 350 milliamps) to which the magnitude (e.g., peak or average magnitude) of the current through the LED light source may be regulated to ensure that the LED light source is illuminated to the appropriate intensity and/or color. An LED light source driven by the voltage load control technique may be characterized by a rated voltage (e.g., approximately 15 volts) to which the voltage across the LED light source may be regulated to ensure proper operation of the LED light source. If an LED light source rated for the voltage load control technique includes multiple parallel strings of LEDs, a current balance regulation element may be used to ensure that the parallel strings have the same impedance so that the same current is drawn in each of the parallel strings.

The light output of an LED light source may be dimmed. Methods for dimming an LED light source may include, for example, a pulse-width modulation (PWM) technique and a constant current reduction (CCR) technique. In pulse-width modulation dimming, a pulsed signal with a varying duty cycle may be supplied to the LED light source. For example, if the LED light source is being controlled using a current load control technique, the peak current supplied to the LED light source may be kept constant during an on-time of the duty cycle of the pulsed signal. The duty cycle of the pulsed signal may be varied, however, to vary the average current supplied to the LED light source, thereby changing the intensity of the light output of the LED light source. As another example, if the LED light source is being controlled using a voltage load control technique, the voltage supplied to the LED light source may be kept constant during the on-time of the duty cycle of the pulsed signal. The duty cycle of the load voltage may be varied, however, to adjust the intensity of the light output. Constant current reduction dimming may be used if an LED light source is being controlled using the current load control technique. In constant current reduction dimming, current may be continuously provided to the LED light source. The DC magnitude of the current provided to the LED light source, however, may be varied to adjust the intensity of the light output.

Examples of LED drivers are described in U.S. Pat. No. 8,492,987, issued Jul. 23, 2013, entitled LOAD CONTROL DEVICE FOR A LIGHT-EMITTING DIODE LIGHT SOURCE; U.S. Pat. No. 9,655,177, issued May 16, 2017, entitled FORWARD CONVERTER HAVING A PRIMARY-SIDE CURRENT SENSE CIRCUIT; and U.S. Pat. No. 9,247,608, issued Jan. 26, 2016, entitled LOAD CONTROL DEVICE FOR A LIGHT-EMITTING DIODE LIGHT SOURCE; the entire disclosures of which are hereby incorporated by reference.

### SUMMARY OF THE INVENTION

As described herein, a load control device for controlling the intensity of a lighting load may be configured to turn on the lighting load to obtain a fast turn-on time that may be substantially consistent across different lighting loads that have different load voltages. The load control device may comprise a power converter circuit that may be configured to receive a first voltage and to produce a second voltage across a capacitor, and a control circuit that is operatively coupled to the power converter circuit for controlling the power converter circuit to generate the second voltage across the capacitor. The control circuit may be configured to determine a learned voltage (e.g., a learned capacitor voltage and/or a learned load voltage) from the magnitude of the second voltage of the capacitor. For example, the control circuit may measure the magnitude of the second voltage of the capacitor and/or store the measured voltage as the learned voltage. The control circuit may determine an operating parameter for the power converter circuit as a function of the learned voltage. The control circuit may be configured to control the power converter circuit according to the operating parameter while the capacitor is charging until the magnitude of the second voltage reaches a threshold.

In an example, the load control device may also include a load regulation circuit configured to receive the second voltage (e.g., a bus voltage) and to control the magnitude of a load current conducted through the lighting load. The control circuit may be operatively coupled to the load regulation circuit for controlling the magnitude of the load current to control the intensity of the lighting load. The control circuit may determine an on-time for controlling a semiconductor switch of the power converter circuit as a function of the learned voltage, and control the semiconductor switch conductive using the pre-load on-time to charge the capacitor until the magnitude of the second voltage reaches the threshold.

In another example, the power converter circuit may operate as a load regulation circuit to control the magnitude of the load current conducted through the lighting load. The control circuit may be operatively coupled to the power converter circuit for controlling the magnitude of the load current to control the intensity of the lighting load. The control circuit may set a magnitude of a target-current control signal for controlling the power converter circuit based on the learned voltage to charge the capacitor until the magnitude of the second voltage reaches the threshold.

### BRIEF DESCRIPTION OF THE DRAWINGS

FIG. 1 is a simplified block diagram of an example light-emitting diode (LED) driver for controlling the intensity of an LED light source.

FIG. 2 is a simplified flowchart of an example turn-on procedure for controlling a power converter circuit of an LED driver.

FIG. 3 is a simplified schematic diagram of an example LED driver showing a power converter circuit and an LED drive circuit.

FIG. 4 is a plot showing an example relationship between a learned load voltage and an on-time for controlling a field-effect transistor of the power converter circuit of FIG. 3.

FIGS. 5A and 5B show example waveforms of a bus voltage of the LED driver of FIG. 3 turning on two different LED light sources.

FIG. 6 is a simplified flowchart of another example turn-on procedure for controlling a power converter circuit of an LED driver.

FIG. 7 is a simplified block diagram of another example LED driver.

FIG. 8 is a simplified schematic diagram of another example LED driver.

FIG. 9A is an example plot of a relationship between an operating frequency and a target current of the LED driver of FIG. 8.

FIG. 9B is an example plot of a relationship between a magnitude of a target-current control signal and the target current of the LED driver of FIG. 8.

FIGS. 10A and 10B show example waveforms illustrating the operation of the LED driver of FIG. 8.

FIG. 11A shows example waveforms illustrating the operation of the LED driver of FIG. 8 when the LED driver is learning a load voltage.

FIG. 11B shows example waveforms illustrating the operation of the LED driver of FIG. 8 when the LED driver is turning on an LED light source using the learned load voltage.

FIG. 12 is a simplified flowchart of another example turn-on procedure for controlling a power converter circuit of an LED driver.

### DETAILED DESCRIPTION OF THE INVENTION

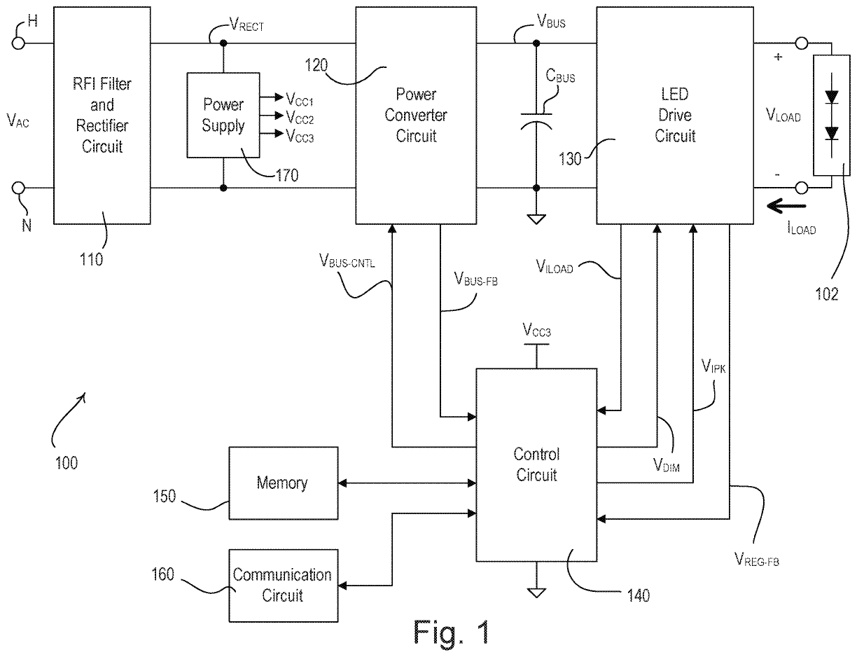

FIG. 1 is a simplified block diagram of a light-emitting diode (LED) driver 100 for controlling the intensity of an LED light source 102 (e.g., an LED light engine). The LED light source 102 is shown as a plurality of LEDs connected in series but may comprise a single LED or a plurality of LEDs connected in parallel or a suitable combination thereof, depending on the particular lighting system. In addition, the LED light source 102 may alternatively comprise one or more organic light-emitting diodes (OLEDs). The LED driver 100 may be adapted to work with a plurality of different LED light sources, which may be rated to operate using different load control techniques, different dimming techniques, and different magnitudes of load current and voltage.

The LED driver 100 may comprise a hot terminal H and a neutral terminal N for receiving an alternating-current (AC) voltage V_{AC} from an AC power source (not shown). The LED driver 100 may comprise a radio-frequency (RFI) filter and rectifier circuit 110, which may receive the AC voltage V_{AC}. The RFI filter and rectifier circuit 110 may operate to minimize the noise provided on the AC power source and to generate a rectified voltage V_{RECT}. The LED driver 100 may comprise a power converter circuit 120, e.g., a buck-boost flyback converter, which may receive the rectified voltage V_{RECT} and generate a variable direct-current (DC) bus voltage V_{BUS} across a capacitor (e.g., a storage capacitor, such as a bus capacitor C_{BUS}). The power converter circuit 120 may alternatively comprise any suitable power converter circuit for generating an appropriate bus voltage, such as, for example, a boost converter, a buck converter, a single-ended primary-inductance converter (SEPIC), a Ćuk converter, or other suitable power converter circuit. The power converter circuit 120 may also provide electrical isolation between the AC power source and the LED light source 102, and/or operate as a power factor correction (PFC) circuit to adjust the power factor of the LED driver 100 towards a power factor of one.

The LED driver 100 may comprise a load regulation circuit, e.g., an LED drive circuit 130, which may receive the bus voltage V_{BUS} and control the amount of power delivered to the LED light source 102 so as to control the intensity of the LED light source. The LED drive circuit 130 may comprise a controllable-impedance circuit, such as a linear regulator, as will be described in greater detail below. To control the amount of power delivered to the LED light source 102, the LED drive circuit 130 may be configured to control the magnitude of a load current I_{LOAD} through the LED light source 102 and/or the magnitude of a load voltage V_{LOAD} across the LED light source.

The LED driver 100 may include a control circuit 140 for controlling the operation of the power converter circuit 120 and/or the LED drive circuit 130. The control circuit 140 may comprise, for example, a controller or any other suitable processing device, such as, for example, a microcontroller, a programmable logic device (PLD), a microprocessor, an application specific integrated circuit (ASIC), or a field-programmable gate array (FPGA). The control circuit 140 may be configured to control the LED drive circuit 130 to turn the LED light source 102 on and off and to adjust (e.g., dim) a present intensity L_{PRES} of the LED light source 102 towards a target intensity L_{TRGT}, which may range across a dimming range of the LED light source, e.g., between a low-end intensity L_{LE} (e.g., approximately 0.1-10%) and a high-end intensity L_{HE} (e.g., approximately 100%). The control circuit 140 may be configured to control the LED drive circuit 130 to control the load voltage V_{LOAD} across the LED light source 102 and/or the load current I_{LOAD} through the LED light source to control the amount of power delivered to the LED light source (e.g., depending upon a mode of operation of the LED driver as will be described in greater detail below). In an example, when power is first applied to the LED driver 100, the control circuit 140 may be configured to execute a startup routine before executing a turn-on routine (e.g., a turn-on procedure) to illuminate the LED light source 102.

The control circuit 140 may be configured to control the magnitude of the load current I_{LOAD} through the LED light source 102 or the load voltage V_{LOAD} across the LED light source using two different modes of operation: a current load control mode (e.g., for using the current load control technique) and a voltage load control mode (e.g., for using the voltage load control technique). The control circuit 140 may be configured to adjust the magnitude to which the LED drive circuit 130 controls the load current I_{LOAD} through the LED light source 102 in the current load control mode, or the magnitude to which the LED drive circuit 130 controls the load voltage V_{LOAD} across the LED light source in the voltage load control mode. When operating in the current load control mode, the control circuit 140 may be configured to control the intensity of the LED light source 102 using two different dimming modes: a PWM dimming mode (e.g., for using the PWM dimming technique) and a CCR dimming mode (e.g., for using the CCR dimming technique). When operating in the voltage load control mode, the LED driver 100 may be configured to adjust the amount of power delivered to the LED light source 102 using the PWM dimming technique.

The control circuit 140 may be coupled to a memory 150 for storing operational characteristics of the LED driver 100 (e.g., the target intensity L_{TRGT}, the low-end intensity L_{LE}, the high-end intensity L_{HE}, etc.). The memory 150 may be implemented as an external integrated circuit (IC) or as an internal circuit of the control circuit 140. The LED driver 100 may also comprise a communication circuit 160, which may be coupled to, for example, a wired communication link or a wireless communication link, such as a radio-frequency (RF) communication link or an infrared (IR) communication link. The control circuit 140 may be configured to determine the target intensity L_{TRGT} of the LED light source 102 or the operational characteristics stored in the memory 150 in response to digital messages received via the communication circuit 160. The control circuit 140 may be configured to execute the turn-on routine, e.g., in response to receiving a command to turn on the LED light source 102.

The LED driver 100 may further comprise a power supply 170, which may receive the rectified voltage V_{RECT} and generate a plurality of direct-current (DC) supply voltages for powering the circuitry of the LED driver. Specifically, the power supply 170 may generate a first non-isolated supply voltage V_{CC1} (e.g., approximately 14 volts) for powering the control circuitry of the power converter circuit 120, a second isolated supply voltage V_{CC2} (e.g., approximately 9 volts) for powering the control circuitry of the LED drive circuit 130, and a third non-isolated supply voltage V_{CC3} (e.g., approximately 5 volts) for powering the control circuit 140.

As previously mentioned, the control circuit 140 may manage the operation of the power converter circuit 120 and/or the LED drive circuit 130 to control the intensity of the LED light source 102. The control circuit 140 may receive from the power converter circuit 120 a bus voltage feedback signal V_{BUS-FB}, which may be representative of the magnitude of the bus voltage V_{BUS}. The control circuit 140 may provide a bus voltage control signal V_{BUS-CNTL} to the power converter circuit 120 for controlling the magnitude of the bus voltage V_{BUS} towards a target bus voltage V_{BUS-TRGT} (e.g., from approximately 8 volts to 60 volts). When operating in the current load control mode, the LED drive circuit 130 may control a peak magnitude I_{PK} of the load current I_{LOAD} conducted through the LED light source 102 between a minimum load current I_{LOAD-MIN} and a maximum load current I_{LOAD-MAX} in response to a peak current control signal V_{IPK} provided by the control circuit 140.

The control circuit 140 may receive a load current feedback signal V_{ILOAD}, which may be representative of an average magnitude I_{AVE} of the load current I_{LOAD} flowing through the LED light source 102. The control circuit 140 may also receive a regulator voltage feedback signal V_{REG-FB} that may be representative of the magnitude of a regulator voltage V_{REG} (e.g., a controllable-impedance voltage) across the linear regulator of the LED drive circuit 130 as will be described in greater detail below. The difference between the magnitudes of the bus voltage V_{BUS} and the regulator feedback voltage V_{REG-FB} may be representative of the magnitude of the load voltage V_{LOAD} across the LED light source 102.

The control circuit 140 may be configured to control the LED drive circuit 130 to control the amount of power delivered to the LED light source 102 using the two different modes of operation (e.g., the current load control mode and the voltage load control mode). During the current load control mode, the LED drive circuit 130 may regulate the peak magnitude I_{PK} of the load current I_{LOAD} through the LED light source 102 in response to the load current feedback signal V_{ILOAD} (e.g., using closed loop control). The target load current I_{TRGT} may be stored in the memory 150 and may be programmed to be any specific magnitude depending upon the LED light source 102.

To control the intensity of the LED light source 102 during the current load control mode, the control circuit 140 may control the LED drive circuit 130 to adjust the amount of power delivered to the LED light source 102 using the PWM dimming technique and/or the CCR dimming technique. Using the PWM dimming technique, the control circuit 140 may control the peak magnitude I_{PK} of the load current I_{LOAD} through the LED light source 102 to the target load current I_{TRGT} and pulse-width modulate the load current I_{LOAD} to dim the LED light source 102 and achieve the target load current I_{TRGT}. Specifically, the LED drive circuit 130 may control a duty cycle DC_{ILOAD} of the load current I_{LOAD} in response to a duty cycle DC_{DIM} of a dimming control signal V_{DIM} provided by the control circuit 140. The intensity of the LED light source 102 may be dependent upon the duty cycle DC_{ILOAD} of the pulse-width modulated load current I_{LOAD}. Using the CCR dimming technique, the control circuit 140 may not pulse-width modulate the load current I_{LOAD}, but instead may adjust the magnitude of the target load current I_{TRGT} so as to adjust the average magnitude I_{AVE} of the load current I_{LOAD} through the LED light source 102 (which may be equal to the peak magnitude I_{PK} of the load current I_{LOAD} in the CCR dimming mode).

During the voltage load control mode, the LED drive circuit 130 may regulate the magnitude (e.g., the DC voltage) of the load voltage V_{LOAD} across the LED light source 102 to a target load voltage V_{TRGT}. The target load voltage V_{TRGT} may be stored in the memory 150 and may be programmed to be any specific magnitude depending upon the LED light source 102. The control circuit 140 may be configured to dim the LED light source 102 using only the PWM dimming technique during the voltage load control mode. Specifically, the control circuit 140 may adjust a duty cycle DC_{VLOAD} of the load voltage V_{LOAD} to dim the LED light source 102. An example of a configuration procedure for the LED driver 100 is described in greater detail in U.S. Pat. No. 8,492,988, issued Jul. 23, 2013, entitled CONFIGURABLE LOAD CONTROL DEVICE FOR LIGHT-EMITTING DIODE LIGHT SOURCES, the entire disclosure of which is hereby incorporated by reference.

The control circuit 140 may be configured to determine or learn (e.g., measure or receive an indication of) one or more operational characteristics of the LED light source 102 (e.g., learned load characteristics). For example, when the control circuit 140 is operating in the current control mode, the control circuit may be configured to determine the magnitude of a voltage representative of the magnitude of the load voltage V_{LOAD}. During the current control mode, the magnitude of the load voltage V_{LOAD} generated across the LED light source 102 may be dependent upon the magnitude of the load current I_{LOAD} (e.g., the target load current I_{TRGT} to which the control circuit 140 is regulating the load current I_{LOAD}) as well as the internal circuitry of the LED light source. The control circuit 140 may be configured to determine (e.g., measure) the magnitude of the voltage that is representative of the magnitude of the load voltage V_{LOAD} (e.g., when the target intensity L_{TRGT} is at the high-end intensity L_{HE}) and/or to store the measurement in the memory 150 as a learned load voltage V_{LEARNED}.

Since the control circuit 140 may operate to minimize the regulator voltage V_{REG} across the linear regulator of the LED drive circuit 130 (e.g., to approximately 0.4-0.6 V), the magnitude of the bus voltage V_{BUS} may be approximately equal to the load voltage V_{LOAD} and thus representative of the magnitude of the load voltage V_{LOAD}. The control circuit 140 may be configured to determine (e.g., measure) the magnitude of the bus voltage V_{BUS} stored in the bus capacitor C_{BUS} using the bus voltage feedback signal V_{BUS-FB} from the power converter circuit 120 and/or store the measurement in the memory 150 as the learned load voltage V_{LEARNED} (e.g., a learned capacitor voltage). The control circuit 140 may be configured to calculate the magnitude of the load voltage V_{LOAD} by subtracting the magnitude of a regulator voltage V_{REG} (e.g., as determined from the regulator voltage feedback signal V_{REG-FB}) from the magnitude of the bus voltage V_{BUS} and use the calculated value as the learned load voltage V_{LEARNED}. The control circuit 140 may include a load voltage measurement circuit (not shown) coupled across the LED light source 102 for directly measuring the magnitude of the load voltage V_{LOAD}, which may be stored as the learned load voltage V_{LEARNED}. Additionally or alternatively, the control circuit 140 may be configured to determine (e.g., measure) the magnitude of a voltage that is representative of the magnitude of the load voltage V_{LOAD} at the low-end intensity L_{LE} and/or store the measurement in the memory 150 as the learned load voltage V_{LEARNED}.

The control circuit 140 may be configured to control the power converter circuit 120 and/or the LED drive circuit 130 using the learned load voltage V_{LEARNED}. For example, the control circuit 140 may be configured to control the power converter circuit 120 in response to the learned load voltage V_{LEARNED} when turning on the LED light source 102. The control circuit 140 may be configured to control the rate at which the bus capacitor C_{BUS} charges in response to the learn load voltage V_{LEARNED} to ensure that the bus voltage V_{BUS} quickly increases to the appropriate level and the LED light source 102 is illuminated as soon as possible. For example, in response to receiving a command to turn on the LED light source 102 and/or in response to power being applied to the LED driver 100 to turn on the LED light source, the control circuit 140 may control the power converter circuit 120 using open loop control in response to the magnitude of the learned load voltage V_{LEARNED} until the magnitude of the bus voltage V_{BUS} reaches or exceeds a charging threshold V_{TH-CH}. The charging threshold V_{TH-CH} may be, for example, a function of the learned load voltage V_{LEARNED}. For example, the control circuit 140 may be configured to determine an operating parameter (e.g., a pre-load parameter) as a function of the learned load voltage V_{LEARNED} and use the operating parameter to control the power converter circuit 120 using open loop control (e.g., as will be described in greater detail below). In addition, the charging threshold V_{TH-CH} may be a fixed threshold (e.g., a predetermined threshold). After the magnitude of the bus voltage V_{BUS} reaches or exceeds a bus voltage threshold V_{TH-BUS}, the control circuit 140 may then begin to control the power converter circuit 120 using closed loop control in response to the magnitude of the bus voltage feedback signal V_{BUS-FB} to regulate the magnitude of the bus voltage V_{BUS} towards the target bus voltage V_{BUS-TRGT}.

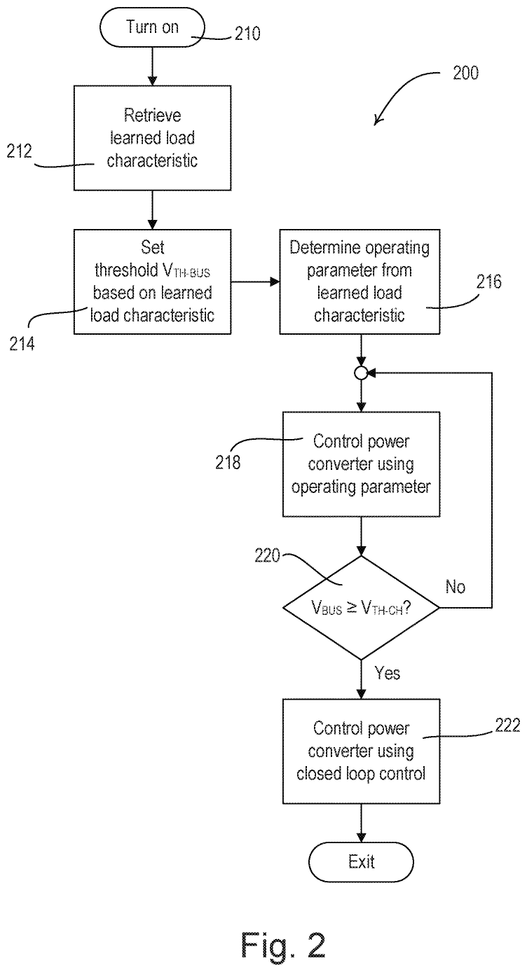

FIG. 2 is a simplified flowchart of an example turn-on procedure 200 for controlling a power converter circuit of an LED driver (e.g., the power converter circuit 120 of the LED driver 100). For example, the turn-on procedure 200 may be executed by a control circuit (e.g., the control circuit 140) at step 210 in response to receiving a command to turn on the LED light source 102 and/or in response to power being applied to the LED driver to turn on the LED light source. The control circuit may retrieve a learned load characteristic (e.g., the learned load voltage V_{LEARNED}) from the memory 150 at step 212 and may determine the value of the charging threshold V_{TH-CH} as a function of the learned load voltage V_{LEARNED} at step 214. The control circuit may determine an operating parameter (e.g., a pre-load on-time) for the power converter circuit as a function of the learned load voltage V_{LEARNED} at step 216 and control the power converter circuit using the operating parameter at step 218. While the magnitude of a capacitor voltage (e.g., the bus voltage V_{BUS}) is less than the charging threshold V_{TH-CH} at step 220, the control circuit may continue to control the power converter circuit using the operating parameter at step 218. When the magnitude of the capacitor voltage is greater than or equal to the charging threshold V_{TH-CH} at step 220, the control circuit may begin to control the power converter circuit using closed loop control at step 222 to regulate the magnitude of the capacitor voltage towards a target capacitor voltage (e.g., the target bus voltage V_{BUS-TRGT}), before the turn-on procedure 200 exits.

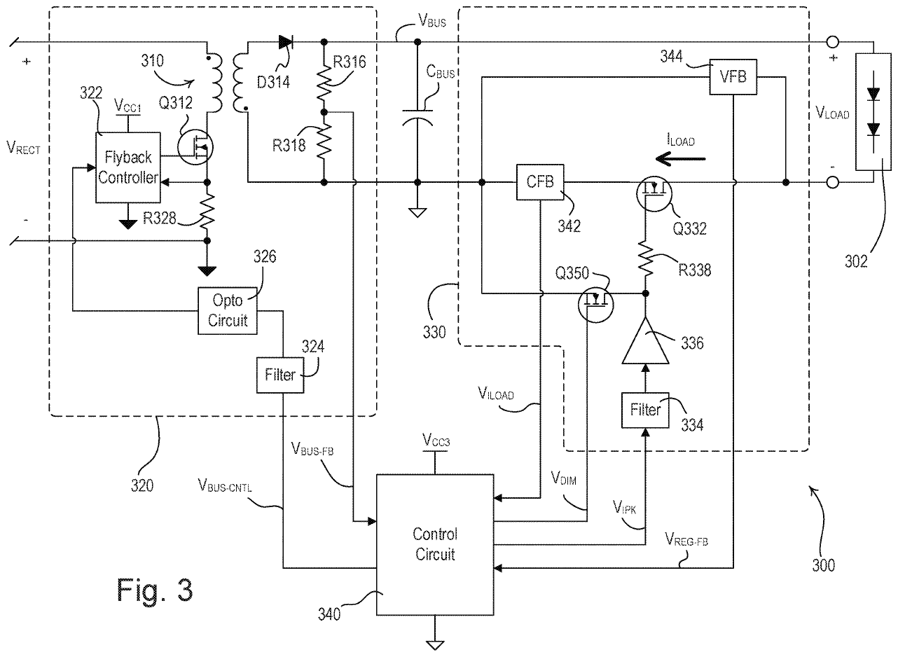

FIG. 3 is a simplified schematic diagram of a load control device, e.g., an LED driver 300 (such as the LED driver 100 of FIG. 1) for controlling the intensity of an LED light source 302. The LED driver 300 may comprise a flyback converter circuit 320 (e.g., the power converter circuit 120), an LED drive circuit 330 (e.g., the LED drive circuit 130), and a control circuit 340 (e.g., the control circuit 140). The flyback converter circuit 320 may comprise a flyback transformer 310 having a primary winding coupled in series with a flyback switching transistor, e.g., a field-effect transistor (FET) Q312, or other suitable semiconductor switch. The secondary winding of the flyback transformer 310 may be coupled to a bus capacitor C_{BUS} via a diode D314. The power converter circuit 320 may comprise a voltage divider comprising two resistors R316, R318 coupled across the bus capacitor C_{BUS} for generating a bus voltage feedback signal V_{BUS-FB}.

The control circuit 340 may generate a bus voltage control signal V_{BUS-CNTL} for controlling a flyback controller 322 of the flyback converter circuit 320. The flyback controller 322 may receive the bus voltage control signal V_{BUS-CNTL} from the control circuit 140 via a filter circuit 324 (e.g., a resistor-capacitor filter) and an optocoupler circuit 326, which may provide electrical isolation between the power converter circuit 320 and the control circuit 340. The flyback controller 322 may also receive a control signal representative of the current through the FET Q312 from a feedback resistor R328, which may be coupled in series with the FET. The flyback controller 322 may render the FET Q312 conductive and non-conductive to selectively conduct current through the flyback transformer 310 to thus generate the bus voltage V_{BUS}. For example, the flyback controller 322 may be configured to adjust an on-time t_{ON} of the FET Q312 (e.g., the time that the FET Q312 conductive during each operating cycle of the power converter circuit 320) in response to the bus voltage control signal V_{BUS-CNTL} to control the magnitude of the bus voltage V_{BUS}.

The LED drive circuit 330 may comprise a linear regulator (e.g., a controllable-impedance circuit) including a power semiconductor switch, e.g., a regulation field-effect transistor (FET) Q332, coupled in series with the LED light source 302 for conducting a load current I_{LOAD} through the LED light source. The control circuit 340 may generate a peak current control signal V_{IPK} that may be coupled to the gate of the regulation FET Q332 through a filter circuit 334, an amplifier circuit 336, and a gate resistor R338. The control circuit 340 may be configured to control a duty cycle DC_{IPK} of the peak current control signal V_{IPK} to control a peak magnitude I_{PK} of the load current I_{LOAD} conducted through the LED light source 302 to a target load current I_{TRGT}.

The LED drive circuit 330 may comprise a load current feedback circuit 342 coupled in series with the regulation FET Q332 and a regulator voltage feedback circuit 344 coupled in parallel with the regulation FET Q332. The load current feedback circuit 342 may generate a load current feedback signal V_{ILOAD}, which may be provided to the control circuit 340 and may be representative of an average magnitude I_{AVE} of the load current I_{LOAD}. The regulator voltage feedback circuit 344 may generate the regulator voltage feedback signal V_{REG-FB}, which may also be provided to the control circuit 340 and may be representative of the regulator voltage V_{REG} generated across the series combination of the regulation FET Q332 and the load current feedback circuit 342. Other examples of feedback circuits for the LED drive circuit 330 are described in greater detail in U.S. Pat. No. 8,466,628, issued Jun. 18, 2013, entitled CLOSED-LOOP LOAD CONTROL CIRCUIT HAVING A WIDE OUTPUT RANGE, the entire disclosure of which is hereby incorporated by reference.

When operating in the current load control mode, the control circuit 340 may control the regulation FET Q332 to operate in the linear region, such that the peak magnitude I_{PK} of the load current I_{LOAD} may be dependent upon the DC magnitude of the gate voltage at the gate of the regulation transistor Q332. In other words, the regulation FET Q332 may provide a controllable-impedance in series with the LED light source 302. If the magnitude of the regulator voltage V_{REG} drops too low, the regulation FET Q332 may be driven into the saturation region, such that the regulation FET Q332 may become fully conductive and the control circuit 340 may no longer be able to control the peak magnitude I_{PK} of the load current I_{LOAD}. Therefore, the control circuit 340 may adjust the magnitude of the bus voltage V_{BUS} to prevent the magnitude of the regulator voltage V_{REG} from dropping below a minimum regulator voltage threshold V_{REG-MIN} (e.g., approximately 0.4 volts). In addition, the control circuit 340 may also be configured to adjust the magnitude of the bus voltage V_{BUS} to control the magnitude of the regulator voltage V_{REG} to be less than a maximum regulator voltage threshold V_{REG-MAX} (e.g., approximately 0.6 volts) to prevent the power dissipated in regulation FET Q332 from becoming too large, thus increasing the total efficiency of the LED driver 300.

When operating in the voltage load control mode, the control circuit 340 may be configured to drive the regulation FET Q332 into the saturation region, such that the magnitude of the load voltage V_{LOAD} may be approximately equal to the magnitude of the bus voltage V_{BUS} (minus the small voltage drops due to the on-state drain-source resistance R_{DS-ON} of the FET regulation Q332 and the resistance of the feedback resistor R344).

The LED drive circuit 330 may also comprise a dimming FET Q350, which may be coupled between the gate of the regulation FET Q332 and circuit common. The dimming control signal V_{DIM} from the control circuit 340 may be provided to the gate of the dimming FET Q350. When the dimming FET Q350 is rendered conductive, the regulation FET Q332 may be rendered non-conductive, and when the dimming FET Q250 is rendered non-conductive, the regulation FET Q332 may be rendered conductive. While using the PWM dimming technique during the current load control mode, the control circuit 340 may adjust the duty cycle DC_{DIM} of the dimming control signal V_{DIM} to thus control when the regulation FET conducts the load current I_{LOAD} and thus the intensity of the LED light source 302. For example, the control circuit 340 may generate the dimming control signal V_{DIM} using a constant PWM frequency f_{DIM} (e.g., approximately 500 Hz).

When using the PWM dimming technique in the current load control mode, the control circuit 340 may be configured to control the peak magnitude IPK of the load current I_{LOAD} in response to the load current feedback signal V_{ILOAD} to maintain the average magnitude I_{AVE} of the load current I_{LOAD} constant (e.g., at the target lamp current I_{TRGT}). When using the CCR dimming technique during the current load control mode, the control circuit 340 may maintain the duty cycle DC_{DIM} of the dimming control signal V_{DIM} at a high-end dimming duty cycle DC_{HE} (e.g., approximately 0%, such that the FET Q332 may always be conductive) and may adjust the target load current I_{TRGT} (via the duty cycle DC_{IPK} of the peak current control signal V_{IPK}) to control the intensity of the LED light source 302.

When operating in the current load control mode, the control circuit 340 may be configured to determine or learn (e.g., measure or receive an indication of) a voltage that is representative of the magnitude of the load voltage V_{LOAD} generated across the LED light source 302 and/or store the learned magnitude in a memory (e.g., the memory 150) as a learned load voltage V_{LEARNED}. For example, when the control circuit is controlling the intensity of the LED light source 302 to the high-end intensity L_{HE}, the control circuit 340 may determine (e.g., measure) the magnitude of the bus voltage V_{BUS} using the bus voltage feedback signal V_{BUS-FB} from the flyback converter circuit 320 and/or store the measurement in the memory as the learned load voltage V_{LEARNED}. The control circuit 340 may be configured to determine (e.g., measure) the magnitude of the bus voltage V_{BUS}, for example, during the startup routine (e.g., when power is first applied to the LED driver 300) and/or after the startup routine (e.g., when the magnitude of the bus voltage V_{BUS} is at a steady state condition).

The control circuit 340 may control the flyback converter circuit 320 in response to the learned load voltage V_{LEARNED} when turning on the LED light source 302 to control the rate at which the bus capacitor C_{BUS} charges to ensure that the LED light source 302 is illuminated quickly after receiving a command to turn on the LED light source 302 and/or after power is applied to the LED driver 300 to turn on the LED light source. When a command to turn on the LED light source 302 has been received and/or power has been applied to the LED driver 300 to turn on the LED light source, the control circuit 340 may be configured to control the flyback converter circuit 320 using open loop control in response to the magnitude of the learned load voltage V_{LEARNED} until the magnitude of the bus voltage V_{BUS} reaches or exceeds a bus voltage threshold V_{TH-BUS} (e.g., the charging threshold V_{TH-CH}). The control circuit 340 may be configured to retrieve the learned load voltage V_{LEARNED} from the memory and may determine the value of the bus voltage threshold V_{TH-BUS} as a function of the learned load voltage V_{LEARNED} (e.g., V_{TH-BUS} =η·V_{LEARNED}), where η is a constant that may be, for example, approximately 0.85.

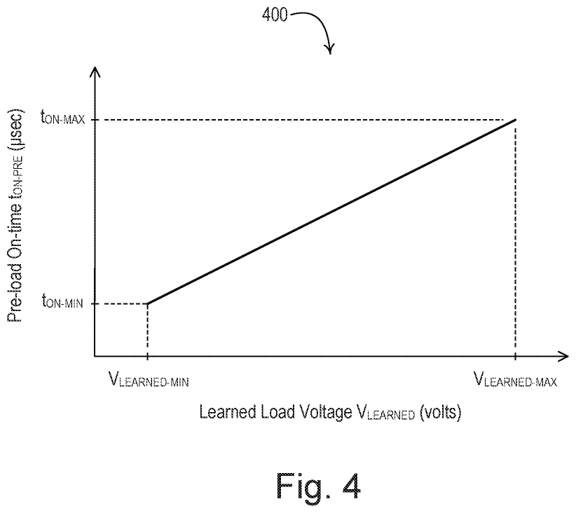

The control circuit 340 may also be configured to determine an operating parameter for the flyback converter circuit 320 as a function of the learned load voltage V_{LEARNED}. For example, the operating parameter for the power converter circuit 320 may be the on-time t_{ON} with which to control the FET Q312 while the bus capacitor C_{BUS} is charging, which may be referred to a “pre-load” on-time t_{ON-PRE}. FIG. 4 is a plot showing an example relationship 400 between the learned load voltage V_{LEARNED} and the pre-load on-time t_{ON-PRE} for the FET Q312. As shown in FIG. 4, the relationship 400 may be, for example, a linear relationship. The relationship 400 may be stored in the memory, e.g., as an equation or as a table. The relationship 400 may range from a minimum pre-load on-time t_{ON-MIN} (e.g., approximately 159.6 μsec) at a minimum learned load voltage V_{LEARNED-MIN} (e.g., approximately 15 volts) to a maximum pre-load on-time t_{ON-MAX} (e.g., approximately 169.9 μsec) at a maximum learned load voltage V_{LEARNED-MAX} (e.g., approximately 38 volts). The values for the pre-load on-time t_{ON-PRE} of the relationship 400 may be chosen such that a turn-on delay time period for LED driver 300 may be approximately the same for different LED light sources that have different resulting load voltages.

The control circuit 340 may be configured to control the on-time t_{ON} for the FET Q312 to the pre-load on-time t_{ON-PRE} using open loop control while the bus capacitor C_{BUS} is charging and the magnitude of the bus voltage V_{BUS} is less than the bus voltage threshold V_{TH-BUS}. When the magnitude of the bus voltage V_{BUS} reaches or exceeds the bus voltage threshold V_{TH-BUS}, the control circuit 340 may then begin to control the flyback converter circuit 320 using closed loop control (e.g., by adjusting the on-time t_{ON} of the FET Q312 in response to the magnitude of the bus voltage feedback signal V_{BUS-FB}) to regulate the magnitude of the bus voltage V_{BUS} towards the target bus voltage V_{BUS-TRGT}.

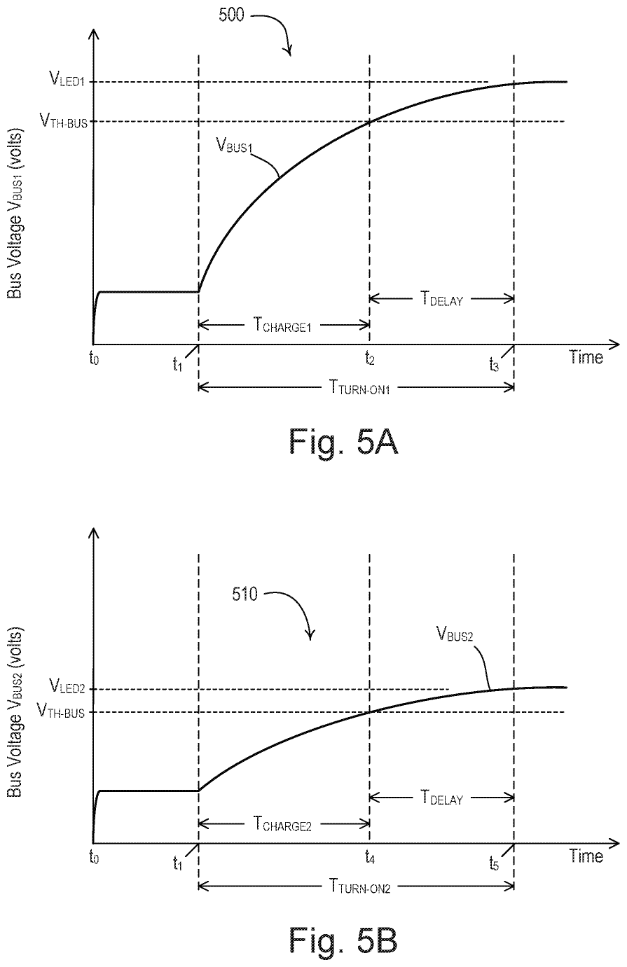

FIGS. 5A and 5B show example waveforms of bus voltages V_{BUS1}, V_{BUS2} of an LED driver while the LED driver (e.g., the LED driver 300) is turning on two different LED light sources. For example, FIG. 5A shows a waveform 500 of the first bus voltage V_{BUS1} when turning on an LED light source that has a first learned load voltage V_{LED1} of approximately 38 volts and FIG. 5B shows a waveform 510 of the second bus voltage V_{BUS2} when turning on an LED light source that has a second learned load voltage V_{LED2} of approximately 15 volts. FIGS. 5A and 5B both show the magnitude of the bus voltage V_{BUS} with respect to time when power is first applied to the LED driver to turn on the LED light sources.

After power is applied at time t₀, a control circuit (e.g., the control circuit 340) of the LED driver may execute a startup routine (e.g., a boot mode) until time t₁ when the control circuit begins controlling a power converter circuit (e.g., the flyback converter circuit 320) to charge a bus capacitor across which the bus voltages V_{BUS1}, V_{BUS2} are produced. The magnitude of the first bus voltage V_{BUS1} may exceed a charging threshold, e.g., a bus voltage threshold V_{TH-BUS}, which may be function of the first learned load voltage V_{LED1} (e.g., V_{TH-BUS}=0.85·V_{LED1}), at time t₂ as shown in FIG. 5A. While the bus capacitor is charging for a first charging time period T_{CHARGE1} between times t₁ and t₂, the control circuit may control the power converter circuit using open loop control with an operating parameter determined as a function of the first learned load voltage V_{LED1} (e.g., as described above). After the first bus voltage V_{BUS1} exceeds the bus voltage threshold V_{TH-BUS} at time t₂, the control circuit may control the power converter circuit using closed loop control to regulate the magnitude of the first bus voltage V_{BUS1} towards a target bus voltage. The control circuit may control the power converter circuit using closed loop control for a control loop delay period T_{DELAY} from time t₂ until the LED light source turns on at time t₃. Thus, the LED light source may turn on after a turn-on delay time period T_{TURN-ON1} from when the control circuit begins controlling the power converter circuit at time t₁.

Similarly, as shown in FIG. 5B, the magnitude of the second bus voltage V_{BUS2} may exceed the bus voltage threshold V_{TH-BUS} at time t₄. The value of the bus voltage threshold V_{TH-BUS} may be lower in FIG. 5B than in FIG. 5A since the second learned load voltage V_{LED2} is lower than the first learned load voltage V_{LED1}. The control circuit may control the power converter circuit with an operating parameter using open loop control for a second charging time period T_{CHARGE2} between times t₁ and t₄. Since the control circuit may determine the operating parameter as a function of the first and second learned load voltage V_{LED1}, V_{LED2}, the values of the first and second charging time periods T_{CHARGE1}, T_{CHARGE2} may be approximately equal. After the magnitude of the second bus voltage V_{BUS2} exceeds the bus voltage threshold V_{TH-BUS} at time t₄, the control circuit may control the power converter circuit using closed loop control for the control loop delay period T_{DELAY} from time t₄ until the LED light source turns on at time t₅, such that the LED light source may turn on after a turn-on delay time period T_{TURN-ON2}. Since the control loop delay period T_{DELAY} may be a constant parameter (e.g., independent of the learned load voltages V_{LED1}, V_{LED2}), the first and second turn-on delay time periods T_{TURN-ON1}, T_{TURN-ON2} may be approximately equal.

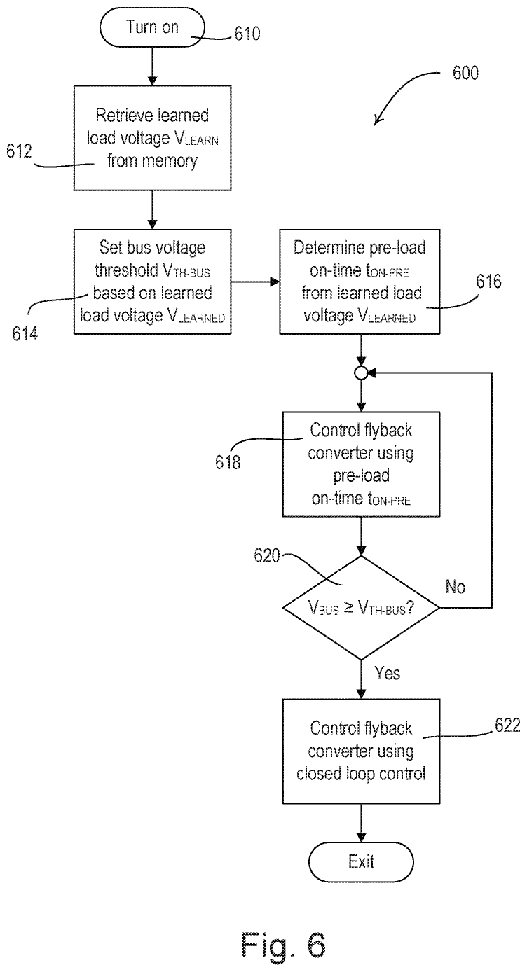

FIG. 6 is a simplified flowchart of an example turn-on procedure 600 for controlling a power converter circuit of an LED driver (e.g., the flyback converter circuit 320 of the LED driver 300). For example, the turn-on procedure 600 may be executed by a control circuit (e.g., the control circuit 340) at step 610 in response to receiving a command to turn on a LED light source and/or in response to power being applied to the LED driver to turn on the LED light source. The control circuit may retrieve a learned load characteristic (e.g., the learned load voltage V_{LEARNED}) from memory at step 612 and may determine the value of a charging threshold (e.g., the bus voltage threshold V_{TH-BUS}) as a function of the learned load voltage V_{LEARNED} (e.g., V_{TH-BUS} =η·V_{LEARNED}, where η may be 0.85) at step 614. The control circuit may determine an operating parameter for the power converter circuit (e.g., the pre-load on-time t_{ON-PRE}) as a function of the learned load voltage V_{LEARNED} at step 616 and control the power converter circuit using the pre-load on-time t_{ON-PRE} at step 618. While the magnitude of the bus voltage V_{BUS} is less than the bus voltage threshold V_{TH-BUS} at step 620, the control circuit may continue to control the power converter circuit using the pre-load on-time t_{ON-PRE} at step 618. When the magnitude of the bus voltage V_{BUS} is greater than or equal to the bus voltage threshold V_{TH-BUS} at step 620, the control circuit may begin to control the power converter circuit using closed loop control at step 622 to regulate the magnitude of the bus voltage V_{BUS} towards a target bus voltage, before the turn-on procedure 600 exits.

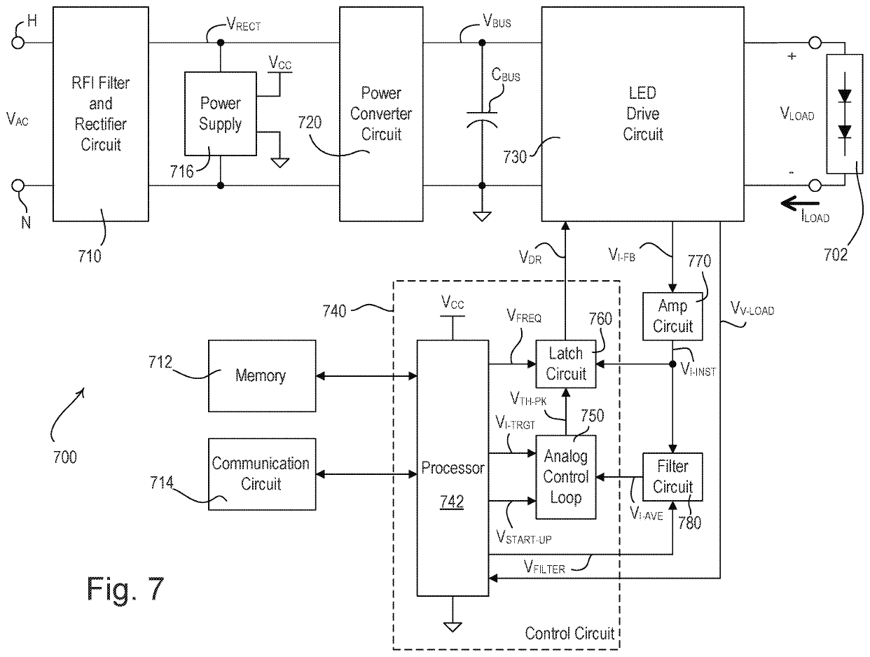

FIG. 7 is a simplified block diagram of a load control device, such as a LED driver 700 for controlling the intensity of an LED light source 702 (e.g., an LED light engine). The LED light source 702 is shown as a plurality of LEDs connected in series but may comprise a single LED or a plurality of LEDs connected in parallel or a suitable combination thereof, depending on the particular lighting system. In addition, the LED light source 702 may alternatively comprise one or more organic light-emitting diodes (OLEDs). The LED driver 700 may be adapted to work with a plurality of different LED light sources, which may be rated at different magnitudes of load current and voltage.

The LED driver 700 may comprise a hot terminal H and a neutral terminal N for receiving an AC voltage V_{AC} from an AC power source (not shown). The LED driver 700 may comprise an RFI filter and rectifier circuit 710, which may receive the AC voltage V_{AC}. The RFI filter and rectifier circuit 710 may operate to minimize the noise provided on the AC power source and to generate a rectified voltage V_{RECT}. The LED driver 700 may comprise a power converter circuit 720 (e.g., a first power converter circuit) and a load regulation circuit, e.g., an LED drive circuit 730 (e.g., a second power converter circuit). The power converter circuit 720 may receive the rectified voltage V_{RECT} and generate a variable DC bus voltage V_{BUS} across a bus capacitor C_{BUS}. The power converter circuit 720 may comprise any suitable power converter circuit for generating an appropriate bus voltage, such as, for example, a boost converter, a buck converter, a buck-boost converter, a flyback converter, a single-ended primary-inductance converter (SEPIC), a Ćuk converter, or other suitable power converter circuit. The power converter circuit 720 may also provide electrical isolation between the AC power source and the LED light source 702, and operate as a PFC circuit to adjust the power factor of the LED driver 100 towards a power factor of one.

The LED drive circuit 730 may receive the bus voltage V_{BUS} and control the amount of power delivered to the LED light source 702 so as to control the intensity of the LED light source. For example, the LED drive circuit 730 may comprise a buck converter, as will be described in greater detail below. To control the amount of power delivered to the LED light source 702, the LED drive circuit 730 may be configured to control an average magnitude of a load current I_{LOAD} conducted through the LED light source 702.

The LED driver 700 may include a control circuit 740 for controlling the operation of the power converter circuit 720 and the LED drive circuit 730. The control circuit 740 may comprise, for example, a controller or any other suitable processing device, such as, for example, a microcontroller, a programmable logic device (PLD), a microprocessor, an application specific integrated circuit (ASIC), or a field-programmable gate array (FPGA). The control circuit 740 may be configured to control the LED drive circuit 730 to control the average magnitude of the load current I_{LOAD} conducted through the LED light source to control the amount of power delivered to the LED light source. The control circuit 740 may be configured to control the LED drive circuit 730 to turn the LED light source 702 on and off and to adjust (e.g., dim) a present intensity L_{PRES} of the LED light source 702 towards a target intensity L_{TRGT}, which may range across a dimming range of the LED light source, e.g., between a low-end intensity L_{LE} (e.g., approximately 0.1%-1.0%) and a high-end intensity L_{HE} (e.g., approximately 100%).

The control circuit 740 may be configured to fade (e.g., gradually adjust over a period of time) the target intensity L_{TRGT} (and thus the present intensity L_{PRES}) of the LED light source 702. The control circuit 740 may be configured to fade the LED light source 702 from off to on by slowly increasing the present intensity L_{PRES} of the LED light source from a minimum fading intensity L_{FADE-MIN}, which may be less than the low-end intensity LLE (e.g., such as approximately 0.02%), to the target intensity L_{TRGT}. The control circuit 740 may be configured to fade the LED light source 702 from on to off by slowly decreasing the present intensity L_{PRES} of the LED light source from an initial intensity greater than or equal to the low-end intensity L_{LE} to the minimum fading intensity L_{FADE-MIN} at which point the control circuit 740 may turn off the LED light source.

The control circuit 740 may be coupled to a memory 712 configured to store operational characteristics of the LED driver 700 (e.g., the target intensity L_{TRGT}, the low-end intensity L_{LE}, the high-end intensity L_{HE}, etc.). The memory 712 may be implemented as an external integrated circuit (IC) or as an internal circuit of the control circuit 740. The LED driver 700 may also comprise a communication circuit 714, which may be coupled to, for example, a wired communication link or a wireless communication link, such as a radio-frequency (RF) communication link or an infrared (IR) communication link. The control circuit 740 may be configured to determine the target intensity L_{TRGT} of the LED light source 702 or the operational characteristics stored in the memory 712 in response to digital messages received via the communication circuit 714. In response to receiving a command to turn on the LED light source 702, the control circuit 740 may be configured to execute the turn-on routine. The LED driver 700 may further comprise a power supply 716, which may receive the rectified voltage V_{RECT}and generate a direct-current (DC) supply voltage V_{CC} (e.g., approximately 5 volts) for powering the low-voltage circuitry of the LED driver. In addition, the power supply 716 may generate one or more additional supply voltages, for example, for powering control circuitry of the power converter circuit 720 and/or the LED drive circuit 730.

The control circuit 740 may comprise a digital control circuit, such as a processor 742, which may be, for example, a microprocessor, a programmable logic device (PLD), a microcontroller, an application specific integrated circuit (ASIC), a field-programmable gate array (FPGA), or other suitable processing device or controller. The control circuit 740 may also comprise an analog control loop circuit 750. The processor 742 and the analog control loop circuit 750 may operate together to control the LED driver circuit 730 to adjust the average magnitude of the load current I_{LOAD} towards a target current I_{TRGT}. The target current I_{TRGT} may be dependent upon the target intensity L_{TRGT} (e.g., a function of the target intensity L_{TRGT}). The processor 742 may generate a target-current control signal V_{I-TRGT}, which may have a DC magnitude or a duty cycle that may indicate the target current I_{TRGT}. The processor 742 may control the DC magnitude or the duty cycle of the target-current control signal V_{I-TRGT} based on the target intensity L_{TRGT} of the LED light source 702.

The control circuit 740 may also comprise a latch circuit 760 that may generate a drive signal V_{DR} for controlling the operation of the LED drive circuit 730 (e.g., for rendering a switching transistor of the LED drive circuit 730 conductive and non-conductive to regulate the average magnitude of the load current ILOAD towards the target current I_{TRGT}). The processor 742 may generate a frequency control signal V_{FREQ} that may set an operating frequency f_{OP} of the LED drive circuit 730. In response to the frequency control signal V_{FREQ}, the latch circuit 760 may control the drive signal V_{DR} to render the switching transistor of the LED drive circuit 730 conductive to start a cycle of the LED drive circuit, at which time the LED drive circuit may begin to conduct an inductor current I_{L} conducted through an inductor (not shown) of the LED drive circuit 730. The analog control loop circuit 750 may generate a peak current threshold V_{TH-PK}, which may be used by the latch circuit 760 to render the switching transistor of the LED drive circuit 730 non-conductive in response to the magnitude of the inductor current I_{L}.

The LED driver 700 may comprise an amplifier circuit 770, which may receive a current feedback signal V_{I-FB} from the LED drive circuit 730. The amplifier circuit 770 may amplify the current feedback signal V_{I-FB} to generate an instantaneous current feedback signal V_{I-INST}, which may indicate an instantaneous magnitude of the inductor current I_{L} flowing through the inductor of the LED drive circuit 730.

The LED driver 700 may further comprise a filter circuit 780, such as a boxcar filter circuit. The filter circuit 780 may receive the instantaneous current feedback signal V_{I-INST} and generate a filtered feedback signal, e.g., an average current feedback signal V_{I-AVE}, which may indicate an average magnitude of the inductor current IL flowing through the inductor of the LED drive circuit 730 (e.g., over a specific time window). The processor 742 may generate a filter control signal V_{FILTER} (e.g., a filter control signal) for controlling the operation of the filter circuit 780, e.g., to control when the filter circuit 780 filters the instantaneous current feedback signal V_{I-INST}. For example, the processor 742 may control the filter control signal V_{FILTER} to allow the filter circuit 780 to filter the instantaneous current feedback signal V_{I-INST} over a filter window period T_{FILTER} during each cycle of the LED drive circuit 730. The processor 742 may control the filter control signal V_{FILTER} in a manner that is synchronous with the frequency control signal V_{FREQ}, e.g., to start a cycle of the LED drive circuit 730 at the beginning of the filter window period T_{FILTER}. For example, the filter window period T_{FILTER} may have the same length during each cycle of the LED drive circuit 730 independent of the frequency of the frequency control signal V_{FREQ}. The magnitude of the average current feedback signal V_{I-AVE} may indicate the average magnitude of the inductor current I_{L} during the filter window period T_{FILTER} (e.g., while the filter circuit 780 is filtering the instantaneous current feedback signal V_{I-INST}).

The analog control loop circuit 750 of the control circuit 740 may receive the average current feedback signal V_{I-AVE} and the latch circuit 760 may receive the instantaneous current feedback signal V_{I-INST}. The analog control loop circuit 750 may adjust the magnitude of the peak current threshold V_{TH-PK} in response to the target-current control signal V_{I-TRGT} and the average current feedback signal V_{I-AVE}. The latch circuit 760 may control the drive signal V_{DR} to render the switching transistor of the LED drive circuit 730 conductive in response to the frequency control signal V_{FREQ} (e.g., at the beginning of a cycle of the LED drive circuit 730). The latch circuit 760 may control the drive signal V_{DR} to render the switching transistor non-conductive in response to the peak current threshold V_{TH-PK} and the instantaneous current feedback signal V_{I-INST}. After rendering the switching transistor of the LED drive circuit 730 non-conductive, the latch circuit 760 may remain in a latched state and maintain the switching transistor non-conductive until the beginning of the next cycle of the LED drive circuit 730.

The control circuit 740 may be configured to determine or learn (e.g., measure or receive an indication of) one or more operational characteristics of the LED light source 702 (e.g., learned load characteristics). For example, the control circuit 740 may be configured to determine a voltage representative of the magnitude of the load voltage V_{LOAD}. The magnitude of the load voltage V_{LOAD} generated across the LED light source 702 may be dependent upon the magnitude of the load current I_{LOAD} (e.g., the target load current I_{TRGT} to which the control circuit 740 is regulating the load current I_{LOAD}) as well as the internal circuitry of the LED light source. The control circuit 740 may be configured to determine (e.g., measure) the magnitude of the load voltage VLOAD and/or store the measurement in the memory 712 as a learned load voltage V_{LEARNED}. The control circuit 740 may be configured to determine (e.g., measure) the magnitude of the load voltage VLOAD using a load voltage feedback signal V_{V-LOAD} received from the LED drive circuit 730. For example, the LED drive circuit 730 may comprise a resistive divider circuit (not shown) coupled across the LED light source 702 for generating the load voltage feedback signal V_{V-LOAD} as a scaled load voltage. The load voltage feedback signal V_{V-LOAD} may be received by an analog-to-digital converter (ADC) of the processor 742 for learning the magnitude of the load voltage V_{LOAD}.

The control circuit 740 may be configured to determine (e.g., measure) the magnitude of the load voltage V_{LOAD} when the target intensity L_{TRGT} is at or near the low-end intensity L_{LE}. For example, the control circuit 740 may be configured to determine (e.g., measure) the magnitude of the load voltage V_{LOAD} while the control circuit 740 is fading the LED light source 702 from on to off, for example, while the average magnitude of the load current I_{LOAD} is within a measurement window that may range from a maximum learning threshold I_{LEARN-MAX} to a minimum learning threshold I_{LEARN-MIN}. The maximum learning threshold I_{LEARN-MAX} and the minimum learning threshold I_{LEARN-MIN} may be functions of a rated (or maximum) current I_{RATED} of the LED light source 702, for example, 0.0020·I_{RATED} and 0.0002·I_{RATED}, respectively.

The control circuit 740 may be configured to control the LED drive circuit 730 using the learned load voltage V_{LEARNED}. For example, the control circuit 740 may be configured to control the LED drive circuit 730 in response to the learned load voltage V_{LEARNED} when turning on the LED light source 702. The control circuit 740 may be configured to charge (e.g., “pre-charge”) an output capacitor (not shown) of the LED drive circuit 730 prior to attempting to turn on the LED light source 702. In response to receiving a command to turn on the LED light source 702 and/or in response to power being applied to the LED driver 700 to turn on the LED light source, the control circuit 740 may pre-charge the output capacitor until the magnitude of the load voltage V_{LOAD} reaches or exceeds a pre-charge voltage threshold V_{TH-PC}, which may be, for example, a function of the learned load voltage V_{LEARNED} (e.g., as will be described in greater detail below). The pre-charging of the output capacitor may allow the LED driver 700 to turn-on the LED light source 702 quickly and consistently, e.g., when fading on to the low-end intensity L_{LE}.

The control circuit 740 may be configured to determine an operating parameter (e.g., a pre-load parameter) as a function of the learned load voltage V_{LEARNED} and use the operating parameter to control the LED drive circuit 730 to pre-charge the output capacitor of the LED drive circuit 730 prior to turning the LED light source 702 on (e.g., as will be described in greater detail below). For example, the control circuit 740 may be configured to determine the DC magnitude or the duty cycle of the target-current control signal V_{I-TRGT} to use while pre-charging the output capacitor of the LED drive circuit 730 as a function of the learned load voltage V_{LEARNED}. In addition, the processor 742 may generate a start-up control signal V_{START-UP} for controlling the analog control loop circuit 750 while pre-charging the output capacitor of the LED drive circuit 730 to maintain the output of the analog control loop circuit 750 at a predetermined voltage.

After the magnitude of the load voltage V_{LOAD} reaches or exceeds the pre-charge voltage threshold V_{TH-PC}, the processor 742 may control the start-up control signal V_{START-UP} to allow the analog control loop circuit 750 to control the LED drive circuit 730 using closed loop control in response to the current feedback signal V_{I-FB} to regulate the magnitude of the load current I_{LOAD} towards the target current I_{TRGT}.

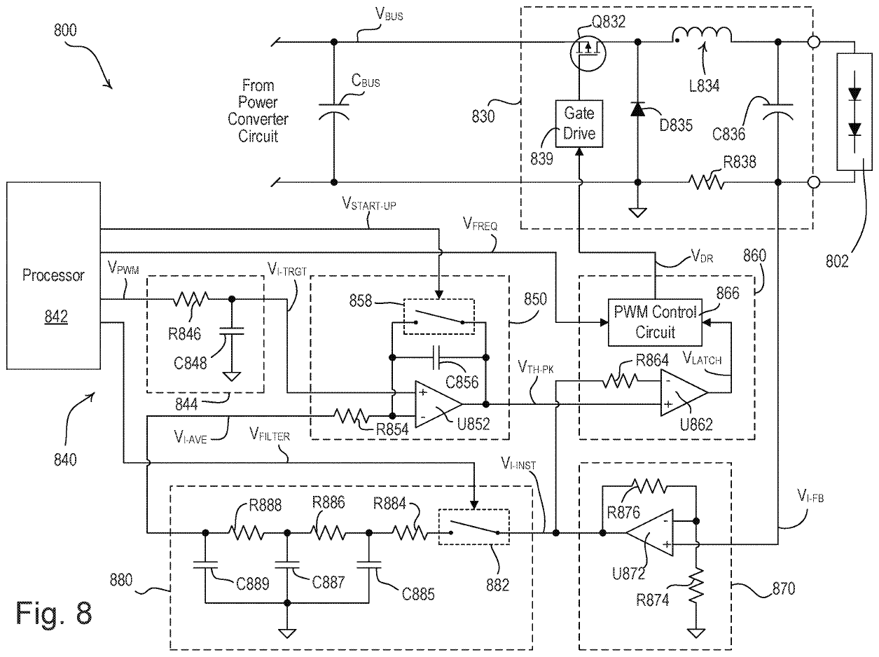

FIG. 8 is a simplified schematic diagram of a load control device, e.g., an LED driver 800 (such as the LED driver 700 of FIG. 1) for controlling the intensity of an LED light source 802. The LED driver 800 may comprise a bus capacitor CBUS for storing a bus voltage V_{BUS}, which may be generated by a first power converter circuit (e.g., the power converter circuit 720 of the LED driver 700). The LED driver 800 may comprise a second power converter circuit, e.g., an LED drive circuit 830, which may be configured to control the magnitude of a load current ILOAD conducted through the LED light source 802. The LED driver 800 may further comprise a control circuit 840, which may be a hybrid analog-digital control circuit (e.g., the control circuit 740 of the LED driver 700). The control circuit 840 may comprise a processor 842, a low-pass filter circuit 844, an analog control loop circuit (e.g., which may include an integrator circuit 850), and a latch circuit 860. The latch circuit 860 may generate a drive signal V_{DR}, which may be provided to the LED driver circuit 830. The LED driver 800 may further comprise an amplifier circuit 870 and a filter circuit 880 (e.g., a boxcar filter circuit) for generating an instantaneous current feedback signal V_{I-INST} and an average current feedback signal V_{I-AVE}, respectively.

As shown in FIG. 8, the LED drive circuit 830 may comprise a buck converter. The LED drive circuit 830 may comprise a switching transistor, e.g., a field-effect transistor (FET) Q832, which may be controlled in response to the drive signal V_{DR} to control the magnitude of the load current I_{LOAD}. The LED drive circuit 830 may also comprise an inductor L834, a switching diode D835, an output capacitor C836, and a feedback resistor R838. The drive signal V_{DR} may be coupled to a gate of the FET Q832 through a gate drive circuit 839. When the FET Q832 is conductive, the inductor L834 may conduct an inductor current I_{L} from the bus capacitor C_{BUS} through the parallel combination of the output capacitor C836 and the LED light source 802. When the FET Q832 is non-conductive, the inductor L834 may conduct the inductor current I_{L} through the switching diode D835 and the parallel combination of the output capacitor C836, and the LED light source 802. The LED light source 802 may conduct the average component of the inductor current I_{L} and the output capacitor C836 may conduct the transient component of the inductor current I_{L}. The average magnitude of the load current I_{LOAD} may be approximately equal to the average magnitude of the inductor current I_{L}.

The current feedback signal V_{I-FB} may be generated across the feedback resistor R838 of the LED drive circuit 830 and may be proportional to the magnitude of the inductor current I_{L}. The current feedback signal V_{I-FB} may be received by the amplifier circuit 870. The amplifier circuit 870 may comprise an operational amplifier U872 and may be configured as a non-inverting amplifier circuit. The operational amplifier U872 may have a non-inverting input that may receive the current feedback signal V_{I-FB}. The amplifier circuit 870 may also comprise a resistor R874 coupled between an inverting input of the operational amplifier U872 and circuit common, and a resistor R876 coupled between the inverting input and an output of the operational amplifier U872. The amplifier circuit 870 may be configured to generate the instantaneous current feedback signal V_{I-INST}, which may be an amplified version of the current feedback signal V_{I-FB} and may indicate the instantaneous magnitude of the inductor current I_{L}.

The filter circuit 880 may filter the instantaneous current feedback signal V_{I-INST} to generate the average current feedback signal V_{I-AVE}, which may indicate the average magnitude of the inductor current I_{L}. The filter circuit 880 may comprise a controllable switching circuit 882 and a low-pass filter circuit (e.g., a third-order low-pass filter circuit) that includes resistors R884, R886, R888 and capacitors C885, C887, C889. The processor 842 may generate a filter control signal V_{FILTER} for rendering the controllable switching circuit 882 conductive and non-conductive. When the controllable switching circuit 882 is conductive, the filter circuit 880 may be configured to filter the instantaneous current feedback signal V_{I-INST} to generate the average current feedback signal V_{I-AVE}. When the controllable switching circuit 882 is non-conductive, the capacitors C885, C887, C889 of the filter circuit 880 may maintain the magnitude of the average current feedback signal V_{I-AVE} at a value that indicates the average magnitude of the inductor current I_{L} during the period of time when the controllable switching circuit 882 was previously conductive.

The processor 842 may generate a pulse-width modulated (PWM) signal V_{PWM}, which may be received by the low-pass filter circuit 844 of the control circuit 840. The low-pass filter circuit 844 may be configured to generate a target-current control signal V_{I-TRGT}, which may have a DC magnitude that indicates the target current I_{TRGT}. For example, the low-pass filter circuit 844 may comprise a resistor-capacitor (RC) circuit having a resistor R846 and a capacitor C848. The processor 842 may be configured to control the duty cycle of the pulse-width modulated signal V_{PWM} to adjust the magnitude of the target-current control signal V_{I-TRGT}.

The average current feedback signal V_{I-AVE} generated by the filter circuit 880 and the target-current control signal V_{I-TRGT} generated by the low-pass filter circuit 844 may be received by the integrator circuit 850. The integrator circuit 850 may comprise an operational amplifier U852 having a non-inverting input coupled to the target-current control signal V_{I-TRGT} and an inverting input coupled to the average current feedback signal V_{I-AVE} via a resistor R854. The integrator circuit 850 may comprise a capacitor C856 coupled between the inverting input and an output of the operational amplifier U852, such that the integrator circuit 850 may be configured to integrate the error between the average current feedback signal V_{I-AVE} and the target-current control signal V_{I-TRGT}. The integrator circuit 850 may generate a peak current threshold V_{TH-PK} having a DC magnitude that may increase or decrease by amounts dependent upon the error between the magnitude of the target-current control signal V_{I-TRGT} and the average current feedback signal V_{I-AVE}. The integrator circuit 850 may comprise a controllable switching circuit 858 coupled in parallel with the capacitor C856. The controllable switching circuit 858 may be rendered conductive and non-conductive in response to a startup control signal V_{START-UP} received from the processor 842 during a startup routine (e.g., as will be described in greater detail below).

The latch circuit 860 may receive the peak current threshold V_{TH-PK} generated by the integrator circuit 850 and the instantaneous current feedback signal V_{I-INST} generated by the amplifier circuit 870. The latch circuit 860 may comprise a comparator U862 configured to compare the magnitude of the instantaneous current feedback signal V_{I-INST} to the magnitude of the peak current threshold V_{TH}. The comparator U862 may generate a latch control signal V_{LATCH} at an output. When the magnitude of the instantaneous current feedback signal V_{I-INST} is less than the magnitude of the peak current threshold V_{TH}, the comparator U862 may drive the latch control signal V_{LATCH} at the output high (e.g., towards the supply voltage V_{CC}). When the magnitude of the instantaneous current feedback signal V_{I-INST} exceeds the magnitude of the peak current threshold V_{TH-PK}, the comparator U862 may drive the latch control signal V_{LATCH} at the output low (e.g., towards circuit common).

The processor 842 may generate a frequency control signal V_{FREQ} that may set an operating frequency f_{OP} of the LED drive circuit 830. The latch circuit 860 may comprise a PWM control circuit 866, which may receive the latch control signal V_{LATCH} from the comparator U262 and the frequency control signal V_{FREQ} from the processor 842. The PWM control circuit 866 may generate the drive signal V_{DR}, which may be received by the gate drive circuit 839 of the LED drive circuit 830. When the frequency control signal V_{FREQ} is driven high at the beginning of a cycle of the LED driver circuit 830, the PWM control circuit 866 may drive the magnitude of the drive signal V_{DR} high, which may render the FET Q832 of the LED drive circuit 830 conductive. When the magnitude of the instantaneous current feedback signal V_{I-INST} exceeds the magnitude of the peak current threshold signal V_{TH}, the comparator U862 may drive the latch control signal V_{LATCH} low, which may cause the PWM control circuit 866 to drive the magnitude of the drive signal V_{DR} low. The PWM control circuit 866 may maintain the magnitude of the drive signal V_{DR} low until the processor 842 drives the magnitude of the frequency control signal V_{FREQ} high once again at the end of the present cycle and the beginning of the next cycle of the LED drive circuit 830.

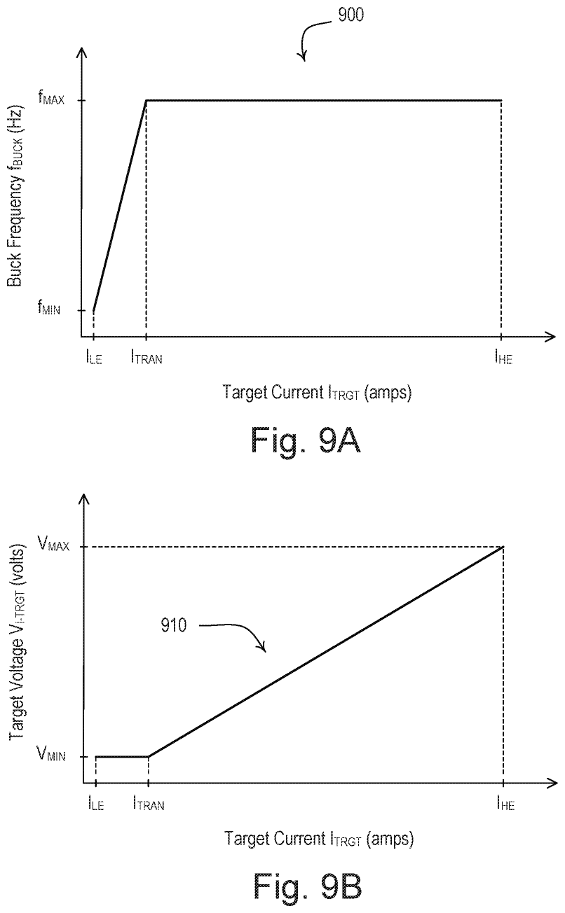

The processor 842 may control the frequency of the frequency control signal V_{FREQ} and the duty cycle of the pulse-width modulated control signal V_{PWM} (and thus the magnitude of the target-current control signal V_{I-TRGT}) in dependence upon the target current I_{TRGT} of the LED light source 802 using open loop control. FIG. 9A is an example plot of a relationship 900 between the frequency of the frequency control signal V_{FREQ} (e.g., the operating frequency f_{OP} of the LED drive circuit 830) and the target current I_{TRGT}. FIG. 9B is an example plot of a relationship 910 between the magnitude of the target-current control signal V_{I-TRGT} and the target current I_{TRGT}. For example, the target current I_{TRGT} may range between a high-end current I_{HE} (e.g., approximately 150 mA) at the high-end intensity L_{HE} and a low-end current I_{LE} (e.g., approximately 150 μA) at the low-end intensity L_{LE}.

The processor 842 may operate in first and second modes of operation depending upon whether the target current I_{TRGT} is less than or greater than approximately a transition current I_{TRAN} (e.g., approximately 16.8 mA). Near the low-end intensity L_{LE} (e.g., when the target current I_{TRGT} is less than approximately the transition current I_{TRAN}), the processor 842 may operate in the first operating mode during which the processor 842 may adjust the frequency of the frequency control signal V_{FREQ} between a minimum operating frequency f_{MIN} and a maximum operating frequency f_{MAX} (e.g., linearly) with respect to the target current I_{TRGT} while holding the magnitude of the target-current control signal V_{I-TRGT} constant (e.g., at a minimum voltage V_{MIN}). Near the high-end intensity L_{HE} (e.g., when the target current I_{TRGT} is greater than or equal to approximately the transition current I_{TRAN}), the processor 842 may operate in the second operating mode during which the processor 842 may adjust the magnitude of the target-current control signal V_{I-TRGT} between the minimum voltage V_{MIN} and a maximum voltage V_{MAX} (e.g., linearly) with respect to the target current I_{TRGT} while holding the frequency control signal V_{FREQ} constant (e.g., at the maximum operating frequency f_{MAX}). For example, the maximum operating frequency f_{MAX} may be approximately 140 kHz and the minimum operating frequency f_{MIN} may be approximately 1250 Hz. For example, the maximum voltage V_{MAX} may be approximately 3.3 V and the minimum voltage V_{MIN} may be approximately 44 mV.

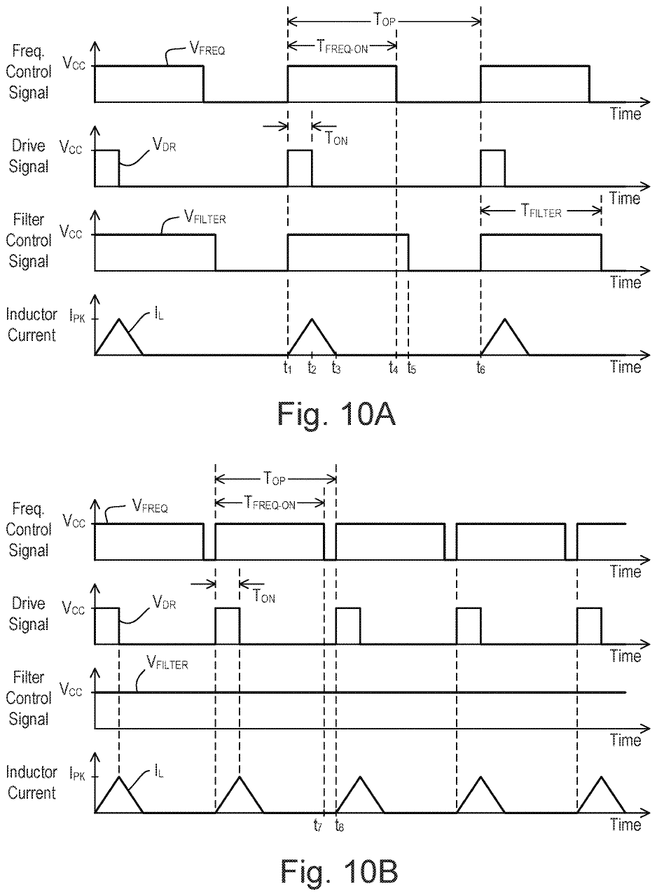

FIGS. 10A and 10B show example waveforms illustrating the operation of the LED driver 800 shown in FIG. 8. FIG. 10A shows example waveforms illustrating the operation of the LED driver 800 when the target current I_{TRGT} is less than the transition current I_{TRAN}. The processor 842 may generate the frequency control signal V_{FREQ} to set the operating frequency f_{OP} of the LED drive circuit 830. For example, an operating period T_{OP} of the LED drive circuit 830 may be equal to the period of the frequency control signal V_{FREQ}. The processor 842 may set the operating frequency f_{OP} (and thus the operating period T_{OP}) in dependence upon the target current I_{TRGT} (e.g., as shown in FIG. 9A). The processor 842 may generate the frequency control signal V_{FREQ} to have a predetermined on-time T_{FREQ-ON}, which may have the same length each cycle of the LED drive circuit 830 (e.g., independent of the frequency of the frequency control signal V_{FREQ} or the target current I_{TRGT}).

The processor 842 may generate the filter control signal V_{FILTER} in a synchronous manner with respect to the frequency control signal V_{FREQ}. For example, the processor 842 may drive both the filter control signal V_{FILTER} and the frequency control signal V_{FREQ} high at the same time to start a cycle of the LED drive circuit 830 (e.g., at time t₁ in FIG. 10A). At time t₁, the PWM control circuit 866 of the latch circuit 860 may drive the magnitude of the drive signal V_{DR} high (e.g., towards the supply voltage V_{CC}) causing the FET Q832 of the LED drive circuit 830 to be rendered conductive. At this time, the inductor L834 of the LED drive circuit 830 may begin to conduct the inductor current I_{L}. When the instantaneous current feedback signal V_{I-INST} (which may be proportional to the magnitude of the inductor current I_{L}) exceeds the magnitude of the peak current threshold signal V_{TH}, the PWM control circuit 866 may drive the magnitude of the drive voltage V_{DR} low (e.g., towards circuit common) as shown at time t₂ of FIG. 10A, which may cause the FET Q832 of the LED drive circuit 830 to be rendered non-conductive. The drive signal V_{DR} may be characterized by an on-time T_{ON} and a period that may be equal to the operating period T_{OP} as shown in FIG. 10A. The PWM control circuit 866 may render the FET Q832 conductive for the length of the on-time T_{ON} of the drive signal V_{DR} during each operating cycle of the LED drive circuit 830. The inductor current I_{L} may have a peak magnitude I_{PK} as shown in FIG. 10A. The magnitude of the inductor current I_{L} may begin to decrease at time t₂ until the magnitude of the inductor current I_{L} drops to zero amps at time t₃.

The processor 842 may drive the frequency control signal V_{FREQ} low at the end of the predetermined on-time T_{FREQ-ON} (e.g., at time t₄ in FIG. 10A). The processor 842 may drive the filter control signal V_{FILTER} low at the end of a filter window period T_{FILTER} (e.g., at time t₅ in FIG. 10A). The processor 842 may drive both the filter control signal V_{FILTER} and the frequency control signal V_{FREQ} high to start another cycle of the LED drive circuit 830 at the end of the operating period T_{OP} (e.g., at time t₆ in FIG. 10A).

When the target current I_{TRGT} is less than the transition current I_{TRAN}, the processor 842 may hold the magnitude of the target-current control signal V_{I-TRGT} constant at the minimum voltage V_{MIN}, and linearly adjust the frequency of the frequency control signal V_{FREQ} between the minimum frequency f_{MIN} and the maximum frequency f_{MAX} as a function of the target current I_{TRGT} (e.g., as shown in FIGS. 9A and 9B). The filter circuit 880 may be configured to filter the instantaneous current feedback signal V_{I-INST} during the filter window period T_{FILTER} each cycle of the LED drive circuit 830. When the target current I_{TRGT} is less than the transition current I_{TRAN}, the filter control signal V_{FILTER} may be a periodic signal characterized by the operating frequency f_{OP}. The processor 842 may maintain the length of the filter window period T_{FILTER} of the filter control signal V_{FILTER} constant from one cycle of the LED driver circuit 830 to the next cycle independent of the frequency of the frequency control signal V_{FREQ}. A duty cycle of the filter control signal V_{FILTER} may vary as the frequency of the frequency control signal V_{FREQ} is adjusted.

Since the target-current control signal V_{I-TRGT} and the filter window period T_{FILTER} are held constant, the on-time T_{ON} of the drive signal V_{DR} may be approximately the same each cycle of the LED drive circuit 830 even though the frequency of the drive signal V_{DR} (e.g., the operating period T_{OP}) may vary in dependence upon the target current I_{TRGT}. As a result, the peak and average magnitudes of the inductor current I_{L} during the filter window period T_{FILTER} may be approximately the same from one cycle to the next of the LED drive circuit 830 independent of the target current I_{TRGT} when the target current I_{TRGT} is less than the transition current I_{TRAN}. The length of the filter window period T_{FILTER} may be sized to ensure that the inductor current I_{L} drops to zero amps before the end of the filter window period T_{FILTER} when the target current I_{TRGT} is less than the transition current I_{TRAN}. When the target current is less than the transition current I_{TRAN}, the LED drive circuit 830 may be configured to operate in a discontinuous mode of operation.

FIG. 10B shows example waveforms illustrating the operation of the LED driver 800 when the target current I_{TRGT} is greater than the transition current I_{TRAN}. When the target current I_{TRGT} is greater than the transition current I_{TRAN}, the processor 842 may linearly adjust the magnitude of the target-current control signal V_{I-TRGT} between the minimum voltage V_{MIN} and the maximum voltage V_{MAX} as a function of the target current I_{TRGT} (e.g., as shown in FIGS. 9A and 9B). In addition, the processor 842 may hold the frequency of the frequency control signal V_{FREQ} constant at the maximum operating frequency f_{MAX} (e.g., causing the operating period T_{OP} to be held constant at a minimum operating period T_{MIN}). When the target current I_{TRGT} is greater than the transition current I_{TRAN}, the processor 842 may control the duty cycle of the filter control signal V_{FILTER} to a maximum filter duty cycle (e.g., 100%). For example, the operating period T_{OP} may be equal to the length of the filter window period T_{FILTER} when the target current I_{TRGT} is greater than the transition current I_{TRAN}. As a result, the processor 842 may drive the filter control signal V_{FILTER} high at all times (e.g., the filter control signal V_{FILTER} is a constant signal) while the target current I_{TRGT} is greater than the transition current I_{TRAN} as shown in FIG. 10B. The average current feedback signal V_{I-AVE} may indicate the average magnitude of the inductor current I_{L} when the target current I_{TRGT} is greater than the transition current I_{TRAN}. Additionally or alternatively, the processor 842 may drive the filter control signal V_{FILTER} high approximately all of the time (e.g., almost all of the time), for example at substantially large duty cycle (e.g., approximately 90% or greater).

Because the processor 842 varies the magnitude of the target-current control signal V_{I-TRGT} as a function of the target current I_{TRGT}, the length of the on-time T_{ON} of the drive signal V_{DR} may vary as a function of the target current I_{TRGT} even though the frequency of the drive signal V_{DR} (e.g., the operating period T_{OP}) is held constant. As the target current I_{TRGT} increases, the peak current I_{PK} of the inductor current may increase to a point at which the LED drive circuit 830 may begin to operate in a continuous mode of operation. Since the minimum operating period T_{MIN} (e.g., the operating period T_{OP} when the target current I_{TRGT} is greater than the transition current I_{TRAN}) may be equal to the length of the filter window time period T_{FILTER}, the processor 842 may be configured to smoothly transition the LED driver 800 between the first operating mode when the target current I_{TRGT} is less than the transition current I_{TRAN} and the second operating mode when the target current I_{TRGT} is greater than the transition current I_{TRAN}.

The length of the predetermined on-time T_{FREQ-ON} of the frequency control signal T_{FREQ} is less than the length of the operating period T_{OP} when the target current I_{TRGT} is greater than the transition current I_{TRAN}. The processor 842 may drive the frequency control signal T_{FREQ} low (e.g., at time t₇ in FIG. 10B) and then high (e.g., at time t₈) at the end of each cycle of the LED drive circuit 830. This causes the PWM control circuit 866 of the latch circuit 860 to stop maintaining the magnitude of the drive signal V_{DR} low, and to drive the magnitude of the drive signal V_{DR} high again when the frequency control signal T_{FREQ} is driven high to begin the next cycle of the LED drive circuit 830 (e.g., at time t₈).

The processor 842 of the control circuit 840 may be configured to determine or learn (e.g., measure or receive an indication of) the magnitude of the load voltage V_{LOAD} (e.g., developed across the capacitor C836) and/or store the measurement in memory (e.g., the memory 712) as a learned load voltage V_{LEARNED} (e.g., a learned capacitor voltage). The magnitude of the load voltage V_{LOAD} generated across the LED light source 802 may be dependent upon the magnitude of the load current I_{LOAD} (e.g., the target load current I_{TRGT} to which the control circuit 840 is regulating the load current I_{LOAD}) as well as the internal circuitry of the LED light source. The processor 842 may be configured to receive a load voltage feedback signal from the LED drive circuit 830 (e.g., the load voltage feedback signal V_{V-LOAD} of the LED driver 100), which may be a scaled version of the load voltage V_{LOAD} generated by a resistive divider circuit (not shown) of the LED drive circuit 830. The processor 842 may sample the load voltage feedback signal using an analog-to-digital converter (ADC) to measure the magnitude of the load voltage V_{LOAD}.

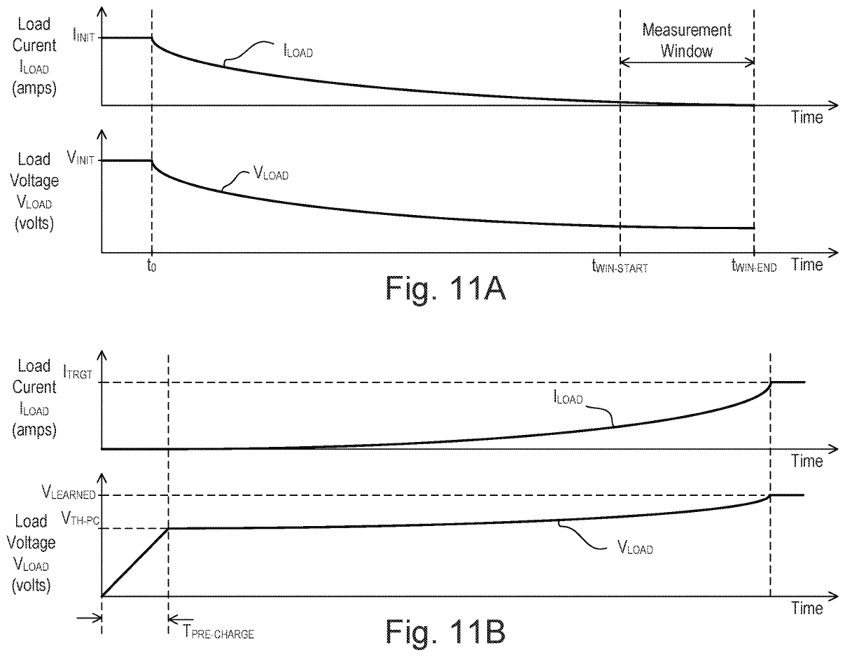

FIG. 11A shows example waveforms illustrating the operation of the LED driver 800 when the processor 842 is learning the load voltage V_{LOAD}. The processor 842 may be configured to determine (e.g., measure) the magnitude of the load voltage V_{LOAD} while the processor 842 is fading the LED light source 802 from on to off. As shown in FIG. 11A, when fading the LED light source 802 from on to off, the processor 842 may begin to decrease the average magnitude of the load current I_{LOAD} from an initial current I_{INIT} at time t₀, at which time the magnitude of the load voltage V_{LOAD} may also begin to decrease, e.g., from an initial voltage V_{INIT}. The processor 842 may be configured to determine (e.g., measure) the magnitude of the load voltage V_{LOAD} while the average magnitude of the load current I_{LOAD} is within a measurement window that may range from a maximum learning threshold I_{LEARN-MAX} and a minimum learning threshold I_{LEARN-MIN} (e.g., between times t_{WIN-START} and t_{WIN-END} as shown in FIG. 11A). The maximum learning threshold I_{LEARN-MAX} and the minimum learning threshold I_{LEARN-MIN} may be functions of a rated (or maximum) current I_{RATED} of the LED light source 802, for example, 0.0020·I_{RATED} and 0.0002·I_{RATED}, respectively. The processor 842 may be configured to periodically sample the load voltage feedback signal during the measurement window, and to process the plurality of samples to determine the learned load voltage V_{LEARNED}. For example, the processor 842 may be configured to process the plurality of samples of the load voltage feedback signal by calculating an average or median value of the plurality of samples or filtering the samples using a digital low-pass filter.

The processor 842 may be configured to measure the load voltage V_{LOAD} and determine the learned load voltage V_{LEARNED} when (e.g., each time that) the processor 842 turns the LED light source 802 off (e.g., fades the LED light source off). The processor 842 may be configured to overwrite the learned load voltage V_{LEARNED} stored in the memory with the learned load voltage V_{LEARNED} determined the last time that the processor 842 turned off the LED light source 802. In addition, the processor 842 may be configured to process the learned load voltages V_{LEARNED} from multiple turn-off events (e.g., calculate the average or median value of the multiple learned load voltages) before overwriting the learned load voltage V_{LEARNED} stored in the memory.

The processor 842 may be configured to control the LED drive circuit 830 using the learned load voltage V_{LEARNED}, for example, when turning on the LED light source 802. FIG. 11B shows example waveforms illustrating the operation of the LED driver 800 when the processor 842 is fading on the LED light source 802 (e.g., fading on to a target intensity L_{TRGT} that corresponds to a target current I_{TRGT}). In response to receiving a command to turn on the LED light source 802 and/or in response to power being applied to the LED driver 800 to turn on the LED light source, the processor 842 may be configured to pre-charge the output capacitor C836 of the LED drive circuit 830 during a pre-charge period T_{PRE-CHARGE} prior to attempting to turn on the LED light source 802. During the pre-charge period T_{PRE-CHARGE}, the processor 842 may be configured to control the duty cycle of the pulse-width modulated signal V_{PWM} (and thus the DC magnitude of the target-current control signal V_{I-TRGT}) as a function of the learned load voltage V_{LEARNED} to cause the output capacitor C836 to charge faster than normal (e.g., faster than if the processor 242 controlled the DC magnitude of the target-current control signal V_{I-TRGT} in response to the target current I_{TRGT} as shown in FIG. 9B). The faster rate at which the output capacitor C836 charges during the pre-charge period T_{PRE-CHARGE} may allow the processor 842 to turn-on the LED light source 802 quickly and consistently, e.g., when fading the LED light source on to the low-end intensity L_{LE}.

The control circuit 840 may be configured to pre-charge the output capacitor C836 of the LED drive circuit 830 until the magnitude of the load voltage V_{LOAD} reaches or exceeds a pre-charge voltage threshold V_{TH-PC}. The pre-charge voltage threshold V_{TH-PC} may be determined, for example, as a function of the learned load voltage V_{LEARNED} (e.g., V_{TH-PC}=α·V_{LEARNED}, where α is a constant that may be, for example, approximately 0.90). Since the magnitude of the load voltage V_{LOAD} may be greater when the LED light source 802 is cold than when the LED light source 802 is warm, the constant α may be sized to be less than one to ensure that the LED drive circuit 830 does not overshoot the learned load voltage V_{LEARNED} when pre-charging the output capacitor C836. Additionally or alternatively, the pre-charge voltage threshold V_{TH-PC} may be determined, for example, using a different function of the learned load voltage V_{LEARNED} (e.g., V_{TH-PC}=V_{LEARNED}−β, where β is a constant that may be, for example, approximately one volt). Additionally or alternatively, the pre-charge voltage threshold V_{TH-PC} may be a fixed threshold (e.g., a predetermined threshold). The processor 842 may be configured to cease pre-charging the output capacitor C836 if the magnitude of the load voltage V_{LOAD} does not exceed the pre-charge voltage threshold V_{TH-PC} within a timeout period. The processor 842 may be configured to select the value of the duty cycle of the pulse-width modulated signal V_{PWM} based on the learned load voltage V_{LEARNED} such that pre-charge period T_{PRE-CHARGE} for the LED driver 800 may be approximately the same for different LED light sources that have different resulting load voltages.

The processor 842 may control the start-up control signal V_{START-UP} to render the controllable switching circuit 858 of the integrator circuit 850 conductive during the pre-charge period T_{PRE-CHARGE}. After the magnitude of the load voltage V_{LOAD} reaches or exceeds the pre-charge voltage threshold V_{TH-PC}, the processor 842 may control the start-up control signal V_{START-UP} to render the controllable switching circuit 858 of the integrator circuit 850 non-conductive. This may allow the integrator circuit 50 and the latch circuit 860 to control the LED drive circuit 830 using closed loop control in response to the current feedback signal V_{I-FB} to regulate the magnitude of the load current I_{LOAD} towards the target current I_{TRGT}.

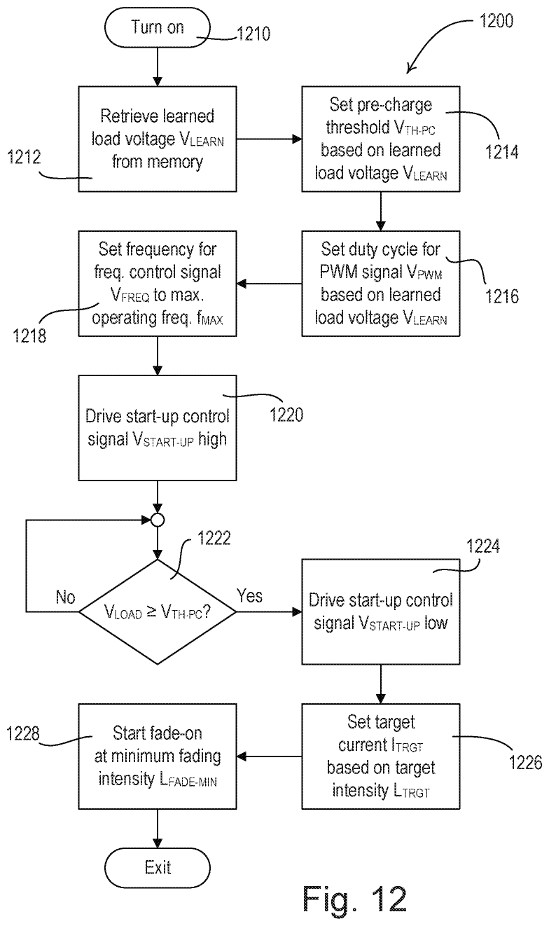

FIG. 12 is a simplified flowchart of an example turn-on procedure 1200 for controlling a power converter circuit of an LED driver (e.g., the LED drive circuit 830 of the LED driver 800). For example, the turn-on procedure 1200 may be executed by a control circuit (e.g., the control circuit 840) at step 1210 in response to receiving a command to turn on a LED light source and/or in response to power being applied to the LED driver to turn on the LED light source. The control circuit may retrieve the learned load voltage V_{LEARNED} from memory at step 1212 and may set the value of the pre-charge threshold V_{TH-PC} based on the learned load voltage V_{LEARNED} at step 1214. At 1216, the control circuit may set the duty cycle of the pulse-width modulated signal V_{PWM} based on the learned load voltage V_{LEARNED}. The control circuit may set the frequency of the frequency control signal V_{FREQ} to be equal to the maximum operating frequency f_{MAX} at 1218, and may drive the startup control signal V_{START-UP} high to render the controllable switching circuit 858 conductive at 1220. When the magnitude of the bus voltage V_{BUS} is greater than or equal to the pre-charge threshold V_{TH-PC} at step 1222, the control circuit may drive the startup control signal V_{START-UP} low to render the controllable switching circuit 858 non-conductive at 1224 and set the target current I_{TRGT} based on the target intensity L_{TRGT} at 1226. The control circuit may begin to fade on the LED light source at 1228 by starting at the minimum fading intensity L_{FADE-MIN} and slowly increasing the present intensity L_{PRES} of the LED light source towards the target intensity L_{TRGT}, before the turn-on procedure 1200 exits.

What is claimed is:

1. A lighting controller, comprising:
power converter circuitry to receive a rectified/filtered voltage input and provide a bus voltage output; and
control circuitry to:
retrieve data representative of a learned voltage associated with a lighting device operatively coupled to the power converter circuitry;
determine a power converter threshold bus voltage using the retrieved learned voltage;
receive at least one input signal that includes data indicative of the power converter circuitry bus voltage output;
determine whether the received data indicative of the power converter circuitry bus voltage output is less than the determined threshold bus voltage; and
responsive to the determination that the power converter circuitry bus voltage output is at or below the determined threshold bus voltage adjust the power converter circuitry bus voltage output via open loop control.

2. The lighting controller of claim 1 wherein responsive to the determination that the power converter bus voltage output is above the determined threshold bus voltage, the control circuitry to further:
adjust the power converter circuitry bus voltage output via closed loop control.

3. The lighting controller of claim 2 wherein to adjust the power converter circuitry bus voltage output via closed loop control, the control circuitry to further:
adjust the power converter circuitry bus voltage output via closed loop control such that the time to reach the threshold voltage is the same for each of a plurality of lighting devices having different threshold voltages.

4. The lighting controller of claim 1 wherein the control circuitry to further:
determine learned voltage associated with operatively connected load device; and
cause a storage of data representative of the determined learned voltage in operatively coupled memory circuitry.

5. A lighting control method, comprising:
receiving by lighting control circuitry, at least one input signal that includes data indicative of an output bus voltage provided by operatively coupled power converter circuitry;
retrieving by the lighting control circuitry, data representative of a learned voltage associated with a lighting device operatively coupled to the power converter circuitry;
determining by the lighting control circuitry, a threshold bus voltage using the retrieved learned voltage;
determining by the lighting control circuitry, whether the received data indicative of the power converter circuitry bus voltage output is less than the determined threshold bus voltage; and
adjusting by the lighting control circuitry, the power converter circuitry bus voltage output via open loop control responsive to the determination that the power converter circuitry bus voltage output is at or below the determined threshold bus voltage.

6. The lighting control method of claim 5, further comprising:
adjusting by the lighting control circuitry, the power converter circuitry bus voltage output via closed loop control responsive to the determination that the power converter bus voltage output is above the determined threshold bus voltage.

7. The lighting control method of claim 6 wherein adjusting the power converter circuitry bus voltage output via closed loop control further comprises:
adjusting by the lighting control circuitry, the power converter circuitry bus voltage output via closed loop control such that the time to reach the threshold voltage is the same for each of a plurality of lighting devices having different threshold voltages.

8. The lighting control method of claim 5, further comprising:
determining by the lighting control circuitry, learned voltage associated with operatively connected load device; and
causing by the lighting control circuitry, a storage of data representative of the determined learned voltage in operatively coupled memory circuitry.

9. A non-transitory, machine-readable, storage device that includes instructions that, when executed by lighting control circuitry, further causes the lighting control circuitry to:
receive at least one input signal that includes data indicative of an output bus voltage provided by operatively coupled power converter circuitry;
retrieve data representative of a learned voltage associated with a lighting device operatively coupled to the power converter circuitry;
determine a threshold bus voltage using the retrieved learned voltage;
determine whether the received data indicative of the power converter circuitry bus voltage output is less than the determined threshold bus voltage; and
adjust the power converter circuitry bus voltage output via open loop control responsive to the determination that the power converter circuitry bus voltage output is at or below the determined threshold bus voltage.

10. The non-transitory, machine-readable, storage device of claim 9 wherein the instructions, when executed by the lighting control circuitry, further cause the lighting control circuitry to:
adjust the power converter circuitry bus voltage output via closed loop control responsive to the determination that the power converter bus voltage output is above the determined threshold bus voltage.

11. The non-transitory, machine-readable, storage device of claim 10 wherein the instructions that cause the lighting control circuitry to adjust the power converter circuitry bus voltage output via closed loop control further cause the lighting control circuitry to:
adjust the power converter circuitry bus voltage output via closed loop control such that the time to reach the threshold voltage is the same for each of a plurality of lighting devices having different threshold voltages.

12. The non-transitory, machine-readable, storage device of claim 9 wherein the instructions, when executed by the lighting control circuitry, cause the lighting control circuitry to:
determine the learned voltage associated with operatively connected load device; and
cause a storage of data representative of the determined learned voltage in operatively coupled memory circuitry.
